(19) United States
(12) Patent Application Publication
(10) Pub. No.: US 2025/0089122 A1
(43) Pub. Date: Mar. 13, 2025

(54) COMMUNICATIONS DURING CELL INACTIVE COMMUNICATION PERIODS

(71) Applicant: QUALCOMM Incorporated, San Diego, CA (US)

(72) Inventors: Diana MAAMARI, San Diego, CA (US); Ahmed Attia ABOTABL, San Diego, CA (US); Marwen ZORGUI, San Diego, CA (US)

(21) Appl. No.: 18/466,672

(22) Filed: Sep. 13, 2023

(51) Int. Cl. H04W 76/28

(52) U.S. Cl. CPC H04W 76/28

(57) ABSTRACT

The described techniques relate to improved methods, systems, devices, and apparatuses that support communications during cell inactive communication periods. For example, some of the described techniques may provide for opportunistic communication during discontinuous reception (DRX) and/or discontinuous transmission (DTX) periods. Because connected user equipments (UEs) may transmit and receive some permitted signaling during an inactive communication period (e.g., in an inactive duration of cell DTX/DRX), the cell is utilizing communication resources in one or more occasions during inactive communication periods. One or more UEs may accordingly opportunistically utilize the one or more occasions to perform other communications that are otherwise restricted during the inactive communication period. For example, a UE may utilize an opportunity to transmit one or more restricted signals, reports, or channel messages to the cell, or to receive one or more restricted signals or channel messages from the cell.

### FIELD OF TECHNOLOGY

The following relates to wireless communications, including communications during cell inactive communication periods.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). The one or more base stations may communicate various types of messages with one or more UEs.

### SUMMARY

The described techniques relate to improved methods, systems, devices, and apparatuses that support communications during cell inactive communication periods. For example, some of the described techniques may provide for opportunistic communication during discontinuous reception (DRX) and/or discontinuous transmission (DTX) periods. In some wireless communication systems, energy consumption is a concern. In 5G NR, for example, network energy saving (NES) procedures may be utilized to save energy for network entity transmission and reception. To save energy, cell DRX may be utilized by one or more network entities to reduce reception activities by restricting a user equipment's (UE's) transmissions during cell DRX. Likewise, cell DTX may be utilized to reduce the network entity transmission to conserve energy. In some examples, a UE may also be configured with DRX and/or DTX to conserve power (e.g., when there is no data to be communicated to/from the UE).

During an inactive communication period of a network entity (e.g., cell DTX/DRX), however, some signaling may be permitted. For example, a radio resource control (RRC)-connected UE may perform random access procedures (e.g., may communicate via a random access channel (RACH) for contention-based and/or contention-free random access procedures). As such, an inactive communication period may have no impact on RACH communication, or other signaling such as paging or system information block (SIB) communication for one or more network entities or one or more UEs. As a result, some UEs (e.g., NES-capable UEs, such as UEs that support operation during cell DXR and/or cell DTX) may perform RACH and/or may receive one or more SIBs during the inactive communication period (e.g., during cell DTX or DRX).

Because connected UEs may perform some permitted signaling (e.g., RACH transmissions, SIB reception) during an inactive communication period (e.g., in an inactive duration of cell DTX/DRX), the cell (e.g., network entity) is utilizing communication resources in one or more occasions during inactive communication periods. One or more UEs may accordingly opportunistically utilize the one or more occasions to perform other communications that are otherwise restricted during the inactive communication period. For example, a UE may utilize an opportunity to transmit one or more restricted signals, reports, or channel messages to the cell (e.g., network entity), or to receive one or more restricted signals or channel messages from the cell. For instance, because one or more NES-capable UEs are permitted to perform a random access procedure or receive SIBs in one or more communication occasions during an inactive duration of cell DTX/DRX, a network entity is activated to receive a RACH message or transmit SIBs during the one or more occasions in the inactive communication period. Accordingly, other restricted uplink or downlink communications may be performed during the one or more occasions in the inactive communication period. For instance, when a network entity is occasionally activated during the inactive communication period for RACH communication, a UE may utilize the one or more occasions to communicate with the network entity (e.g., update the network entity with CSI reporting, to transmit relatively small packets on a configured grant (CG) resource, and/or to receive a tracking reference signal (TRS), among other examples).

A method by a UE is described. The method may include receiving, from a network entity, a message indicating a discontinuous communication configuration for restricting communication by the network entity during one or more inactive communication periods, determining that a communication occasion overlaps with at least one inactive communication period of the one or more inactive communication periods, the communication occasion being associated with a first message type that is permitted in the one or more inactive communication periods, and communicating, with the network entity, a first message during the at least one inactive communication period, the first message having a second message type that is restricted in the one or more inactive communication periods.

A UE is described. The UE may include one or more memories storing processor executable code, and one or more processors coupled with the one or more memories. The one or more processors may individually or collectively be operable to execute the code to cause the UE to receive, from a network entity, a message indicating a discontinuous communication configuration for restricting communication by the network entity during one or more inactive communication periods, determine that a communication occasion overlaps with at least one inactive communication period of the one or more inactive communication periods, the communication occasion being associated with a first message type that is permitted in the one or more inactive communication periods, and communicating, with the network entity, a first message during the at least one inactive communication period, the first message have a second message type that is restricted in the one or more inactive communication periods.

Another UE is described. The UE may include means for receiving, from a network entity, a message indicating a discontinuous communication configuration for restricting communication by the network entity during one or more inactive communication periods, means for determining that a communication occasion overlaps with at least one inactive communication period of the one or more inactive communication periods, the communication occasion being associated with a first message type that is permitted in the one or more inactive communication periods, and means for communicating, with the network entity, a first message during the at least one inactive communication period, the first message having a second message type that is restricted in the one or more inactive communication periods.

A non-transitory computer-readable medium storing code is described. The code may include instructions executable by one or more processors to receive, from a network entity, a message indicating a discontinuous communication configuration for restricting communication by the network entity during one or more inactive communication periods, determine that a communication occasion overlaps with at least one inactive communication period of the one or more inactive communication periods, the communication occasion being associated with a first message type that is permitted in the one or more inactive communication periods, and communicating, with the network entity, a first message during the at least one inactive communication period, the first message have a second message type that is restricted in the one or more inactive communication periods.

Some examples of the method, UEs, and non-transitory computer-readable medium described herein may further include operations, features, means, or instructions for receiving, from the network entity, a control message indicating a configuration of one or more time offsets relative to the communication occasion, where the first message may be communicated within a period including the communication occasion and the one or more time offsets and during the at least one inactive communication period.

Some examples of the method, UEs, and non-transitory computer-readable medium described herein may further include operations, features, means, or instructions for receiving, from the network entity, a control message indicating a configuration of a threshold for determining whether one or more active communication periods of the discontinuous communication configuration may be extended into at least a portion of the one or more inactive communication periods and determining that a duration between a first active communication period of the one or more active communication periods and the communication occasion satisfies the threshold, where the first message may be communicated within a period including the communication occasion and an extension of the first active communication period into the duration in response to the determination.

Some examples of the method, UEs, and non-transitory computer-readable medium described herein may further include operations, features, means, or instructions for activating one or more communication circuitries during at least a portion of the communication occasion that may be during the at least one inactive communication period and deactivating the one or more communication circuitries during at least a portion of the at least one inactive communication period that may be not during the communication occasion.

In some examples of the method, UEs, and non-transitory computer-readable medium described herein, the communication occasion that overlaps with the at least one inactive communication period may be a first periodic communication occasion of a set of multiple periodic communication occasions and the set of multiple periodic communication occasions includes a second periodic communication occasion that overlaps with at least one active communication period before the at least one inactive communication period.

Some examples of the method, UEs, and non-transitory computer-readable medium described herein may further include operations, features, means, or instructions for communicating a second message of the first message type with the network entity during the communication occasion, where the second message includes a random access message, a system information message, or a combination thereof.

In some examples of the method, UEs, and non-transitory computer-readable medium described herein, the first message type that may be permitted in the one or more inactive communication periods includes a random access message type and the communication occasion includes a random access occasion or a physical uplink shared channel (PUSCH) occasion for transmitting one or more random access messages.

In some examples of the method, UEs, and non-transitory computer-readable medium described herein, the first message type that may be permitted in the one or more inactive communication periods includes a system information message type and the communication occasion includes an occasion for receiving one or more system information messages.

In some examples of the method, UEs, and non-transitory computer-readable medium described herein, the first message type that may be permitted in the one or more inactive communication periods includes a paging message type and the communication occasion may include a paging channel occasion for receiving one or more paging messages.

In some examples of the method, UEs, and non-transitory computer-readable medium described herein, the second message type includes a periodic channel state information-reference signal (CSI-RS) type, a semi-persistent scheduling (SPS) CSI-RS type, a TRS type, a positioning reference signal (PRS) type, a physical downlink control channel (PDCCH) message scrambled with a UE-specific radio network temporary identifier (RNTI) type, a PDCCH in a type 3 common search space (CSS) message type, an SPS physical downlink shared channel (PDSCH) message type, a scheduling request (SR) message type, a periodic channel state information (CSI) report type, an SPS CSI report type, a periodic sounding reference signal (SRS) type, an SPS SRS type, a CG PUSCH message type, a CG message type, a buffer status report (BSR) message type, a physical uplink control channel (PUCCH) message type, or a combination thereof.

A method by a network entity is described. The method may include transmitting, to a UE, a message indicating a discontinuous communication configuration for restricting communication by the network entity during one or more inactive communication periods, determining that a communication occasion overlaps with at least one inactive communication period of the one or more inactive communication periods, the communication occasion being associated with a first message type that is permitted in the one or more inactive communication periods, and communicating, with the UE, a first message during at least one inactive communication period, the first message having a second message type that is restricted in the one or more inactive communication periods.

A network entity is described. The network entity may include one or more memories storing processor executable code, and one or more processors coupled with the one or more memories. The one or more processors may individually or collectively be operable to execute the code to cause the network entity to transmit, to a UE, a message indicating a discontinuous communication configuration for restricting communication by the network entity during one or more inactive communication periods, determine that a communication occasion overlaps with at least one inactive communication period of the one or more inactive communication periods, the communication occasion being associated with a first message type that is permitted in the one or more inactive communication periods, and communicating, with the UE, a first message during at least one inactive communication period, the first message have a second message type that is restricted in the one or more inactive communication periods.

Another network entity is described. The network entity may include means for transmitting, to a UE, a message indicating a discontinuous communication configuration for restricting communication by the network entity during one or more inactive communication periods, means for determining that a communication occasion overlaps with at least one inactive communication period of the one or more inactive communication periods, the communication occasion being associated with a first message type that is permitted in the one or more inactive communication periods, and means for communicating, with the UE, a first message during at least one inactive communication period, the first message having a second message type that is restricted in the one or more inactive communication periods.

A non-transitory computer-readable medium storing code is described. The code may include instructions executable by one or more processors to transmit, to a UE, a message indicating a discontinuous communication configuration for restricting communication by the network entity during one or more inactive communication periods, determine that a communication occasion overlaps with at least one inactive communication period of the one or more inactive communication periods, the communication occasion being associated with a first message type that is permitted in the one or more inactive communication periods, and communicating, with the UE, a first message during at least one inactive communication period, the first message have a second message type that is restricted in the one or more inactive communication periods.

Some examples of the method, network entities, and non-transitory computer-readable medium described herein may further include operations, features, means, or instructions for transmitting, to the UE, a control message indicating a configuration of one or more time offsets relative to the communication occasion, where the first message may be communicated within a period including the communication occasion and the one or more time offsets and during the at least one inactive communication period.

Some examples of the method, network entities, and non-transitory computer-readable medium described herein may further include operations, features, means, or instructions for transmitting, to the UE, a control message indicating a configuration of a threshold for determining whether one or more active communication periods of the discontinuous communication configuration may be extended into at least a portion of the one or more inactive communication periods and determining that a duration between a first active communication period of the one or more active communication periods and the communication occasion satisfies the threshold, where the first message may be communicated within a period including the communication occasion and an extension of the first active communication period into the duration in response to the determination.

In some examples of the method, network entities, and non-transitory computer-readable medium described herein, the communication occasion that overlaps with the at least one inactive communication period may be a first periodic communication occasion of a set of multiple periodic communication occasions and the set of multiple periodic communication occasions includes a second periodic communication occasion that overlaps with at least one active communication period before the at least one inactive communication period.

Some examples of the method, network entities, and non-transitory computer-readable medium described herein may further include operations, features, means, or instructions for communicating a second message of the first message type with the UE during the communication occasion, where the second message includes a random access message, a system information message, or a combination thereof.

In some examples of the method, network entities, and non-transitory computer-readable medium described herein, the first message type that may be permitted in the one or more inactive communication periods includes a random access message type and the communication occasion includes a random access occasion or a PUSCH occasion for receiving one or more random access messages.

In some examples of the method, network entities, and non-transitory computer-readable medium described herein, the first message type that may be permitted in the one or more inactive communication periods includes a system information message type and the communication occasion includes an occasion for transmitting one or more system information messages.

In some examples of the method, network entities, and non-transitory computer-readable medium described herein, the first message type that may be permitted in the one or more inactive communication periods includes a paging message type and the communication occasion may include a paging channel occasion for transmitting one or more paging messages.

In some examples of the method, network entities, and non-transitory computer-readable medium described herein, the second message type includes a periodic CSI-RS type, an SPS CSI-RS type, a TRS type, a PRS type, a PDCCH message scrambled with a UE-specific RNTI type, a PDCCH in a type 3 CSS message type, an SPS PDSCH message type, a SR message type, a periodic CSI report type, an SPS CSI report type, a periodic SRS type, an SPS SRS type, a CG PUSCH message type, a CG message type, a BSR message type, a PUCCH message type, or a combination thereof.

### BRIEF DESCRIPTION OF THE DRAWINGS

FIG. 1 shows an example of a wireless communications system that supports communications during cell inactive communication periods in accordance with one or more aspects of the present disclosure.

FIG. 2 shows an example of a wireless communication system that supports communications during cell inactive communication periods in accordance with one or more aspects of the present disclosure.

FIG. 3 shows an example of a timing diagram that supports communications during cell inactive communication periods in accordance with one or more aspects of the present disclosure.

FIG. 4 shows an example of a timing diagram that supports communications during cell inactive communication periods in accordance with one or more aspects of the present disclosure.

FIG. 5 shows an example of a process flow that supports communications during cell inactive communication periods in accordance with one or more aspects of the present disclosure.

FIGS. 6 and 7 show block diagrams of devices that support communications during cell inactive communication periods in accordance with one or more aspects of the present disclosure.

FIG. 8 shows a block diagram of a communications manager that supports communications during cell inactive communication periods in accordance with one or more aspects of the present disclosure.

FIG. 9 shows a diagram of a system including a device that supports communications during cell inactive communication periods in accordance with one or more aspects of the present disclosure.

FIGS. 10 and 11 show block diagrams of devices that support communications during cell inactive communication periods in accordance with one or more aspects of the present disclosure.

FIG. 12 shows a block diagram of a communications manager that supports communications during cell inactive communication periods in accordance with one or more aspects of the present disclosure.

FIG. 13 shows a diagram of a system including a device that supports communications during cell inactive communication periods in accordance with one or more aspects of the present disclosure.

FIGS. 14 through 17 show flowcharts illustrating methods that support communications during cell inactive communication periods in accordance with one or more aspects of the present disclosure.

### DETAILED DESCRIPTION

The described techniques relate to improved methods, systems, devices, and apparatuses that support communications during cell inactive communication periods. For example, some of the described techniques may provide for opportunistic communication during discontinuous reception (DRX) or discontinuous transmission (DTX) periods. In some wireless communication systems, energy consumption is a concern. In fifth generation (5G) New Radio (NR) systems, for example, network energy saving (NES) procedures may be utilized to reduce or minimize power consumption by the network, such as by saving energy for network entity transmission and reception. To save energy, cell DRX may be utilized by one or more network entities to reduce reception activities by restricting a user equipment's (UE's) transmissions during cell DRX. Likewise, cell DTX may be utilized to reduce the network entity transmission to conserve energy. In some examples, a UE may also be configured with DRX and/or DTX to conserve power (e.g., when there is no data to be communicated to/from the UE). As such, approximately aligning the transmission and reception of a wireless transceiver (e.g., aligning UE DRX, semi-persistent scheduling (SPS), and/or channel state information (CSI) reference signaling, among other examples) may achieve enhanced power saving gains for both the network (e.g., network entity) and the UE. Similarly, aligning cell DTX with cell DRX may provide for improved network energy saving. A period in which cell transmission is restricted, cell reception is restricted, or both, may be referred to as an inactive communication period.

During an inactive communication period (e.g., cell DTX/DRX), however, some signaling may be permitted. For example, a radio resource control (RRC)-connected UE may perform random access procedures (e.g., may communicate via a random access channel (RACH)). Here, an inactive communication period may have no impact on RACH communication. Similarly, paging, or system information block (SIB) communication for one or more network entities or one or more UEs may be permitted during one or more inactive communication periods. As a result, NES-capable UEs may perform RACH and/or may receive one or more SIBs during the inactive communication period (e.g., during cell DTX or DRX).

Because connected UEs may perform some permitted signaling (e.g., RACH transmissions, SIB reception) during an inactive communication period (e.g., in an inactive duration of cell DTX/DRX), the cell (e.g., network entity) is utilizing communication resources in one or more communication occasions during inactive communication periods. For example, a network entity may have at least some quantity of antennas and corresponding components active (e.g., powered up, at least partially powered) to enable the RACH reception and/or SIB transmission during the inactive communication periods. One or more UEs may accordingly opportunistically utilize the one or more occasions to perform other communications that are otherwise restricted during the inactive communication period. For example, a UE may utilize an opportunity to transmit one or more restricted signals, reports, or channel messages to the cell (e.g., network entity), or to receive one or more restricted signals or channel messages from the cell. For instance, because one or more NES-capable UEs are permitted to perform a random access procedure or receive SIBs in one or more occasions during an inactive duration of cell DTX/DRX, a network entity is activated to receive a RACH message or transmit SIBs during the one or more occasions in the inactive communication period. Accordingly, other restricted uplink or downlink communications may be performed during the one or more occasions in the inactive communication period. For instance, when a network entity is occasionally activated during the inactive communication period for RACH communication, a UE may utilize the one or more occasions to communicate with the network entity (e.g., update the network entity with CSI reporting, to transmit small packets on a configured grant (CG) resource, and/or to receive a tracking reference signal (TRS), among other examples). As a result, when some communication occasions align with one or more inactive communication periods of cell DRX/DTX, communications efficiency, reduced latency, and improved resource utilization may be achieved through the described techniques, which enable a UE to opportunistically communicate during such occasions.

Aspects of the disclosure are initially described in the context of wireless communications systems. Aspects of the disclosure are also described with reference to timing diagrams and a process flow diagram. Aspects of the disclosure are further illustrated by and described with reference to apparatus diagrams, system diagrams, and flowcharts that relate to communications during cell inactive communication periods.

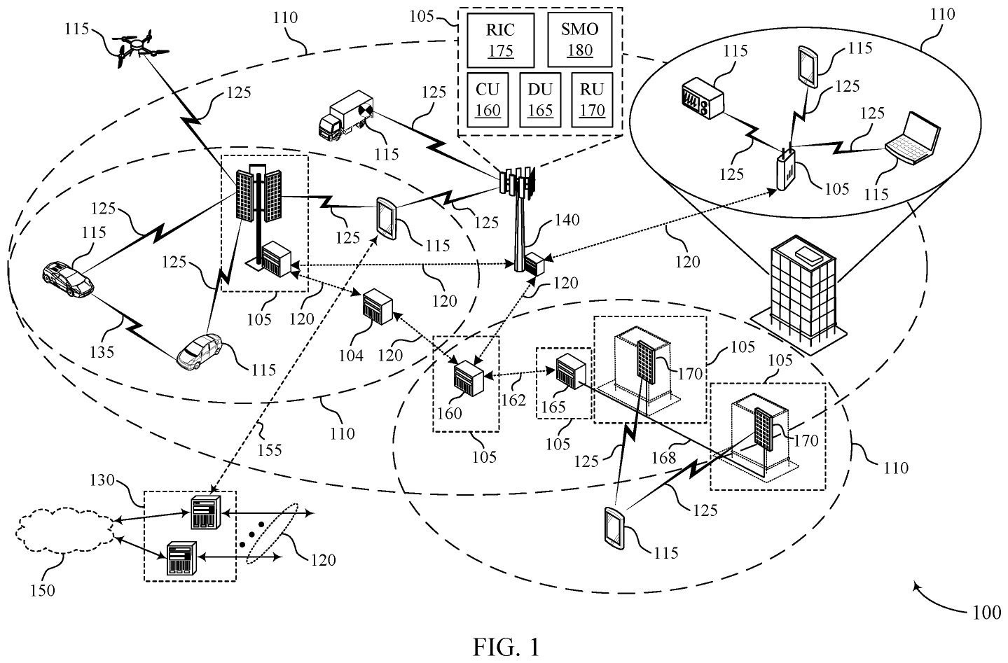

FIG. 1 shows an example of a wireless communications system 100 that supports communications during cell inactive communication periods in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support communications during cell inactive communication periods as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space (CSS) sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

A UE 115 attempting to access a wireless network may perform an initial cell search by detecting a primary synchronization signal (PSS) from a network entity 105. The PSS may enable synchronization of slot timing and may indicate a physical layer identity value. The UE 115 may then receive a secondary synchronization signal (SSS). The SSS may enable radio frame synchronization, and may provide a cell identity value, which may be combined with the physical layer identity value to identify the cell. The SSS may also enable detection of a duplexing mode and a cyclic prefix length. Some systems, such as TDD systems, may transmit an SSS but not a PSS. In some examples, the PSS and the SSS may be located in the central 62 and 72 subcarriers of a carrier, respectively. In some cases, a network entity 105 may transmit synchronization signals (e.g., PSS SSS, and the like) using multiple beams in a beam-sweeping manner through a cell coverage area. In some cases, PSS, SSS, and/or broadcast information (e.g., a physical broadcast channel (PBCH)) may be transmitted within different synchronization signal SSBs on respective directional beams, where one or more SSBs may be included within a burst.

After receiving the PSS and SSS, the UE 115 may receive a master information block (MIB), which may be transmitted via the PBCH. The MIB may contain system bandwidth information, a system frame number (SFN), and a physical HARQ indicator channel (PHICH) configuration. After decoding the MIB, the UE 115 may receive one or more system information blocks (SIBs). For example, SIB1 may contain cell access parameters and scheduling information for other SIBs. Decoding SIB1 may enable the UE 115 to receive SIB2. SIB2 may contain RRC configuration information related to RACH procedures, paging, PUCCH, PUSCH, power control, SRS, and cell barring.

After completing initial cell synchronization, a UE 115 may decode the MIB, SIB1 and SIB2 prior to accessing the network. The MIB may be transmitted on PBCH and may utilize the first four OFDMA symbols of the second slot of the first subframe of each radio frame, and the MIB may use the middle 6 RBs (72 subcarriers) in the frequency domain. The MIB carries a few important pieces of information for UE initial access, including: downlink channel bandwidth in term of RBs, PHICH configuration (duration and resource assignment), and SFN. A new MIB may be broadcast every fourth radio frame (SFN mod 4=0) at and rebroadcast every frame (10 ms). Each repetition is scrambled with a different scrambling code. After reading a MIB (either a new version or a copy), the UE 115 may try different phases of a scrambling code until it gets a successful CRC check. The phase of the scrambling code (0, 1, 2 or 3) may enable the UE 115 to identify which of the four repetitions has been received. Thus, the UE 115 may determine the current SFN by reading the SFN in the decoded transmission and adding the scrambling code phase. After receiving the MIB, a UE 115 may receive one or more SIBs. Different SIBs may be defined according to the type of system information conveyed. A new SIB1 may be transmitted in the fifth subframe of every eighth frame (SFN mod 8=0) and rebroadcast every other frame (20 ms). SIB1 includes access information, including cell identity information, and it may indicate whether a UE is allowed to camp on a cell (e.g., a cell provided by and/or associated with a network entity 105). SIB1 also includes cell selection information (or cell selection parameters). Additionally, SIB1 includes scheduling information for other SIBs. SIB2 may be scheduled dynamically according to information in SIB1, and includes access information and parameters related to common and shared channels. The periodicity of SIB2 may be set to, for example, 8, 16, 32, 64, 128, 256 or 512 radio frames.

After the UE 115 decodes SIB2, it may transmit a RACH preamble to a network entity 105. For example, the RACH preamble may be randomly selected from a set of 64 predetermined sequences, or may be selected from one or more groups of preambles. This may enable the network entity 105 to distinguish between multiple UEs 115 trying to access the system simultaneously. The network entity 105 may respond with a random access response that provides an uplink resource grant, a timing advance, and a temporary cell-radio network temporary identifier (C-RNTI). The UE 115 may then transmit an RRC connection request along with a temporary mobile subscriber identity (TMSI) (if the UE 115 has previously been connected to the same wireless network) or a random identifier. The RRC connection request may also indicate the reason the UE 115 is connecting to the network (e.g., emergency, signaling, data exchange, or the like). The network entity 105 may respond to the connection request with a contention resolution message addressed to the UE 115, which may provide a new C-RNTI. If the UE 115 receives a contention resolution message with the correct identification, it may proceed with RRC setup. If the UE 115 does not receive a contention resolution message (e.g., if there is a conflict with another UE 115) it may repeat the RACH process by transmitting a new RACH preamble.

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some examples of the described techniques relate to communications during cell inactive communication periods. For example, some of the described techniques may provide for opportunistic communication during DRX or DTX periods. In some wireless communication systems, energy consumption is a concern. In 5G NR, for example, NES procedures may be utilized to save network energy for network entity 105 transmission and reception. To save energy, cell DRX may be utilized by one or more network entities 105 to reduce reception activities by restricting a UE's 115 transmissions during cell DRX. Likewise, cell DTX may be utilized to reduce the network entity 105 transmission to conserve energy. In some examples, a UE 115 may also be configured with DRX and/or DTX to conserve power (e.g., when there is no data to be communicated to/from the UE 115). As such, approximately aligning the transmission and reception of a wireless transceiver (e.g., aligning UE 115 DRX, SPS, and/or CSI reference signaling) may achieve enhanced power saving gains for both the network entity 105 and the UE 115. Similarly, aligning cell DTX with cell DRX may provide for improved network energy saving. A period in which cell transmission is restricted, cell reception is restricted, or both, may be referred to as an inactive communication period.

During an inactive communication period (e.g., cell DTX and/or cell DRX), however, some signaling may be permitted. For example, an RRC-connected UE 115 may perform random access procedures (e.g., may communicate via a RACH). For instance, an inactive communication period may have no impact on RACH communication, paging, or SIB communication for one or more network entities 105 or one or more UEs 115. As a result, NES-capable UEs 115 may perform RACH and/or may receive one or more SIBs during the inactive communication period (e.g., during cell DTX and/or cell DRX).

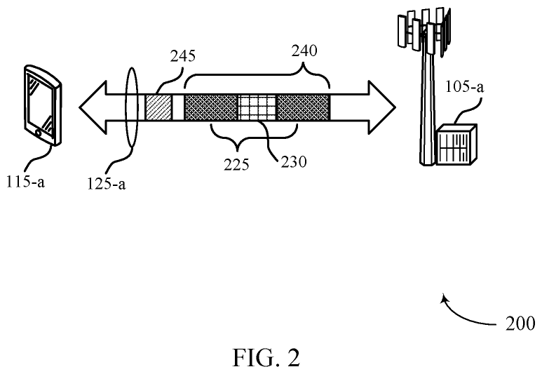

Because connected UEs 115 may perform some permitted signaling (e.g., RACH transmissions, SIB reception) during an inactive communication period (e.g., in an inactive duration of cell DTX/DRX), the cell (e.g., network entity 105) is utilizing communication resources in one or more occasions during inactive communication periods. One or more UEs 115 may accordingly opportunistically utilize the one or more occasions to perform other communications that are restricted during the inactive communication period. For example, a UE 115 may utilize an opportunity to transmit one or more restricted signals, reports, or channel messages to the cell (e.g., network entity 105), or to receive one or more restricted signals or channel messages from the cell. For instance, because one or more NES-capable UEs 115 are permitted to perform a random access procedure or receive SIBs in one or more occasions during an inactive duration of cell DTX/DRX, a network entity 105 is activated to receive a RACH message or transmit SIBs during the one or more occasions in the inactive communication period. Accordingly, other restricted uplink or downlink communications may be performed during the one or more occasions in the inactive communication period. For instance, when a network entity 105 is occasionally activated during the inactive communication period for RACH communication, a UE 115 may utilize the one or more occasions to communicate with the network entity 105 (e.g., update the network entity 105 with CSI reporting, to transmit small packets on a CG resource, and/or to receive a TRS, among other examples). Reception of a TRS may be useful, where utilizing a communication opportunity when the network entity 105 is active in an inactive communication period may help keep one or more UE loops updated. In some examples, the UE 115 and/or the network entity 105 may conduct communication during one or more inactive communication periods as described with reference to one or more of FIGS. 2-5.

FIG. 2 shows an example of a wireless communications system 200 that supports communications during cell inactive communication periods in accordance with one or more aspects of the present disclosure. The wireless communications system 200 may implement aspects of or may be implemented by aspects of the wireless communications system 100. For example, the wireless communications system 200 includes a UE 115-a, which may be an example of a UE 115 described with respect to FIG. 1. The wireless communications system 200 also includes a network entity 105-a, which may be an example of a network entity 105 as described with respect to FIG. 1.

The UE 115-a may communicate with the network entity 105-a using a communication link 125-a, which may be an example of a communication link 125 described with respect to FIG. 1. As used herein, the terms “communication,” “communicating,” and variations thereof may refer to transmission, reception, or a combination of both. The communication link 125-a may include a bi-directional link that enables both uplink and downlink network communications. For example, the UE 115-a may transmit uplink network transmissions, such as uplink control signals or uplink data signals, to the network entity 105-a using the communication link 125-a, and the network entity 105-a may transmit downlink network transmissions, such as downlink control signals or downlink data signals, to the UE 115-a using the communication link 125-a.

The network entity 105-a may transmit, to the UE 115-a, a message 245 indicating a discontinuous communication configuration (e.g., DRX configuration and/or DTX configuration) for restricting communication by the network entity 105-a during one or more inactive communication periods. The UE 115-a may receive the message 245. For instance, the network entity 105-a may transmit an RRC message, a downlink control information (DCI) message, and/or a medium access control-control element (MAC-CE) message indicating the discontinuous communication configuration. In some approaches, the UE 115-a may send capability signaling indicating that the UE 115-a is capable of operating with a discontinuous communication configuration and the message 245 may be in response to the capability signaling.

In some examples, the message 245 may indicate an inactive communication period 240 (e.g., a DRX period and/or a DTX period) in which the network entity 105-a may deactivate one or more communication circuitries (e.g., one or more receive circuitries and/or one or more transmit circuitries). The inactive communication period 240 may be a period in time in which communication with the network entity 105-a is restricted. In some approaches, the network entity 105-a may deactivate one or more communication circuitries during the inactive communication period 240, where one or more communication circuitries may be activated for one or more communication occasions and/or for communication of one or more permitted message types. During the inactive communication period 240, for instance, communication (if any) may be restricted to one or more permitted message types (e.g., one or more first message types) and one or more other message types (e.g., one or more second message types) may be restricted (e.g., generally prohibited or disallowed). In some approaches, the discontinuous communication configuration may be an instruction and/or a command for the UE 115-a to refrain from transmitting one or more second message types to the network entity 105-a during the inactive communication period 240.

The UE 115-a and/or the network entity 105-a may determine that a communication occasion 225 overlaps with at least one inactive communication period 240 of the one or more inactive communication periods. The communication occasion 225 may be a time period in which a communication (e.g., a transmission and/or a reception) is scheduled or permitted. In some examples, the UE 115-a and/or the network entity 105-a may determine that the communication occasion 225 overlaps with the at least one inactive communication period 240 by determining that a start time of a permitted communication, an end time of a permitted communication, or a portion of the communication occasion 225 is within the inactive communication period 240 (e.g., is between a start time and an end time of the inactive communication period 240 and/or overlaps with one or more frames, subframes, and/or slots of the inactive communication period 240).

The communication occasion 225 may be associated with a first message type that is permitted in the one or more inactive communication periods (e.g., the inactive communication period 240). In some examples, the first message type that is permitted in the one or more inactive communication periods (e.g., in the inactive communication period 240) may include a random access message type. In some cases, the UE 115-a (or another UE not shown in FIG. 2) may communicate a message of the first message type with the network entity 105-a during the communication occasion 225. In some examples, the second message may include a random access message (e.g., RACH message) and/or a system information message (e.g., SIB).

In some approaches, the communication occasion 225 may include a random access occasion or a PUSCH occasion for transmitting and/or receiving one or more random access messages. For instance, the communication occasion 225 may be a communication occasion for the UE 115-a to transmit a RACH message to the network entity 105-a or a PUSCH occasion for the UE 115-a to transmit one or more RACH messages to the network entity 105-a. In some examples, the network entity 105-a may receive and/or respond to the one or more RACH messages during (and/or after) the inactive communication period 240 and/or the communication occasion 225.

In some examples, the UE 115-a may activate one or more communication circuitries during at least a portion of the communication occasion 225 that is during the at least one inactive communication period 240. Additionally, or alternatively, the UE 115-a may deactivate one or more communication circuitries during a portion of the at least one inactive communication period 240 that is not during the communication occasion 225.

In some approaches, the first message type that is permitted in the one or more inactive communication periods (e.g., in the inactive communication period 240) may include a system information message type (e.g., a SIB). The communication occasion 225 may include an occasion for transmitting and/or receiving one or more system information messages. For instance, the communication occasion 225 may be a communication occasion for transmitting and/or receiving one or more SIBs. In some examples, the communication occasion 225 may be a communication occasion for the network entity 105-a to transmit one or more SIBs to the UE 115-a. In some approaches, the UE 115-a may receive and/or respond to the one or more SIBs during (and/or after) the inactive communication period 240 and/or the communication occasion 225.

In some examples, the first message type that is permitted in the one or more inactive communication periods (e.g., in the inactive communication period 240) may include a paging message type. The communication occasion 225 may include a paging channel occasion for transmitting and/or receiving one or more paging messages. In some examples, the communication occasion 225 may be a communication occasion for the network entity 105-a to transmit one or more paging messages to the UE 115-a. In some approaches, the UE 115-a may receive and/or respond to the one or more paging messages during (and/or after) the inactive communication period 240 and/or the communication occasion 225.

In some examples, the communication occasion 225 that overlaps with the at least one inactive communication period 240 may be a first periodic communication occasion of a plurality of periodic communication occasions in some examples. The plurality of periodic communication occasions may include a second periodic communication occasion that overlaps with at least one active communication period before or after the at least one inactive communication period 240. For instance, the communication occasion 225 may be one communication occasion 225 of a set of periodic communication occasions, where one or more of the periodic communication occasions may be scheduled outside of the inactive communication period 240.

The UE 115-a may communicate, with the network entity 105-a, a first message 230 during the at least one inactive communication period 240. In the uplink, for example, the UE 115-a may transmit (and/or the network entity 105-a may receive) the first message 230. In the downlink, for example, the network entity 105-a may transmit (and/or the UE 115-a may receive) the first message 230.

The first message may have a second message type that is restricted in the one or more inactive communication periods (e.g., in the inactive communication period 240). For example, because the network entity 105-a is permitting communication (with the first message type, for instance) in the communication occasion 225, the UE 115-a and/or the network entity 105-a may opportunistically communicate a first message 230 that is otherwise restricted during the inactive communication period 240. In some approaches, one or more NES-capable connected UE(s) (e.g., UE 115-a) may perform a RACH procedure and receive one or more SIBs in the inactive communication period 240. In some examples, the inactive communication period 240 may be a period of cell DTX and/or DRX, where the same behavior may be performed for cell DTX and cell DRX. When the network entity 105-a is active to receive a RACH message in the cell DRX and/or DTX inactive communication period, other uplink and/or downlink transmissions may be performed. For example, one or more communication circuitries of the network entity 105-a may be active to permit the first message type for the communication occasion 225. Accordingly, the UE 115-a and/or the network entity 105-a may further utilize the period of activity to allow communication of one or more other restricted messages. For instance, because the network entity 105-a is active in at least a portion of the inactive communication period 240, the UE 115-a may perform uplink and/or downlink transmissions during that window. In some examples, while the network entity 105-a is active during a cell DRX inactive communication period for RACH, then the UE 115-a may utilize the time, to update the network entity 105-a with CSI reporting, to transmit one or more packets on a CG, and/or to receive a TRS.

The second message type (e.g., restricted message type) may include one or more signals or channels for connected mode UEs 115-a. The UE 115-a may not be generally permitted to transmit or receive during the inactive communication period 240 (e.g., a non-active period of cell DTX and/or DRX). In some examples, the second message type may include a periodic CSI-RS type, an SPS CSI-RS, a TRS type, a positioning reference signal (PRS) type, a physical downlink control channel (PDCCH) message scrambled with a UE-specific radio network temporary identifier (RNTI) type, a PDCCH in a type 3 CSS message type, an SPS physical downlink shared channel (PDSCH) message type, a scheduling request (SR) message type, a periodic CSI report type, an SPS CSI report type, a periodic sounding reference signal (SRS) type, an SPS SRS type, a CG physical uplink shared channel (PUSCH) type, a CG message type, a buffer status report (BSR) message type, a physical uplink control channel (PUCCH) message type, or a combination thereof. The UE 115-a may receive in the downlink, for instance, the first message 230 with the second message type, which may include a periodic CSI-RS type, an SPS CSI-RS, a TRS type, a PRS type, a PDCCH message scrambled with a UE-specific RNTI type, a PDCCH in a type 3 CSS message type, and/or an SPS PDSCH message type. Additionally, or alternatively, the UE 115-a may transmit in the uplink, the first message 230 with the second message type, which may include an SR message type, a periodic CSI report type, an SPS CSI report type, a periodic SRS type, an SPS SRS type, a CG PUSCH type, a CG message type, a BSR message type, and/or a PUCCH message type. One or more additional or alternative message types may be included in the second message type (e.g., restricted message type) in some examples.

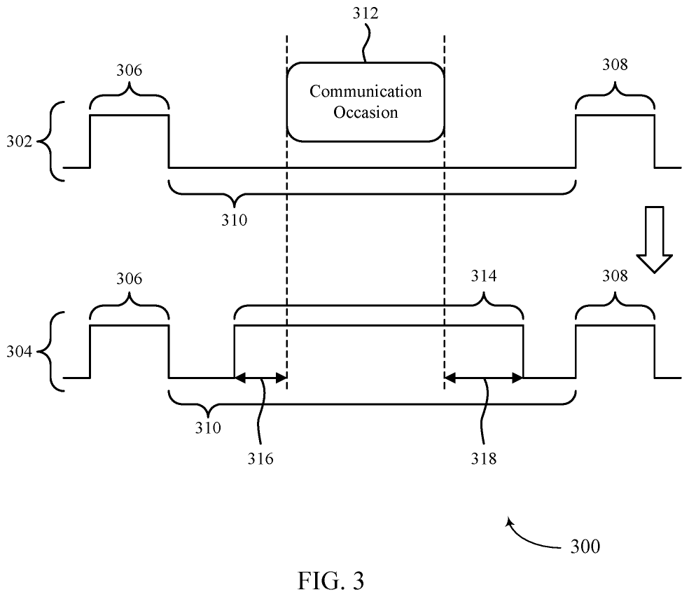

In some examples, the UE 115-a may receive, from the network entity 105-a, a control message indicating a configuration of one or more time offsets relative to the communication occasion 225. The control message may be communicated as part of the message 245 or in a separate message. In some examples, the control message may be an RRC message, a DCI message, and/or a MAC-CE message. The one or more time offsets may include an offset relative to the beginning of the communication occasion 225 and/or an offset relative to the end of the communication occasion 225. In some examples, the first message 230 may be communicated within a period including the communication occasion 225 and the one or more time offsets and during the at least one inactive communication period 240. Examples of offsets are given with reference to FIG. 3.

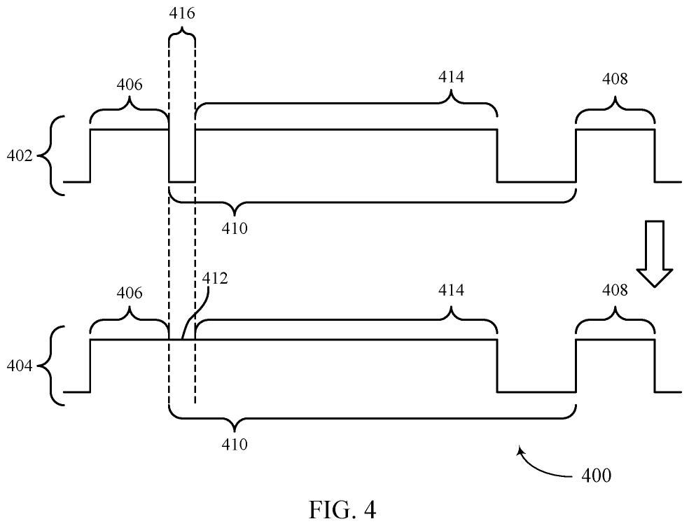

In some cases, the communication occasion 225 may occur with a gap (e.g., a relatively short gap) from an active communication period. An active communication period may occur before (e.g., may precede) the inactive communication period 240 or may occur after (e.g., may follow) the inactive communication period 240. For instance, the communication occasion 225 may occur after a relatively small portion of the inactive communication period 240. In some cases, an active communication period may be extended to bridge to the communication occasion 225 if the length of the gap satisfies a threshold. An example of active communication period extension (e.g., bridging) is given with reference to FIG. 4.

In some examples, the UE 115-a may receive, from the network entity 105-a, a control message indicating a configuration of a threshold for determining whether one or more active communication periods of the discontinuous communication configuration are extended into at least a portion of the one or more inactive communication periods (e.g., the inactive communication period 240). The control message may be communicated as part of the message 245 or in a separate message. In some examples, the control message may be an RRC message, a DCI message, and/or a MAC-CE message. The UE 115-a and/or the network entity 105-a may determine that a duration between a first active communication period of the one or more active communication periods and the communication occasion 225 satisfies the threshold. The first message may be communicated within a period including the communication occasion 225 and an extension of the first active communication period into the duration in response to the determination.

FIG. 3 shows an example of a timing diagram 300 that supports communications during cell inactive communication periods in accordance with one or more aspects of the present disclosure. The timing diagram 300 illustrates a first timeline 302 showing a first active communication period 306, a second active communication period 308, and an inactive communication period 310 without a period for restricted communications.

As illustrated in FIG. 3, a communication occasion 312 may occur during the inactive communication period 310. For example, the communication occasion 312 may include one or more PUSCH occasions. As illustrated in a second timeline 304, a network entity (e.g., network entity 105) and/or a UE (e.g., UE 115) may determine a period 314 in which restricted communication may occur during the inactive communication period 310 based on the communication occasion 312. For instance, during a cell DTX and/or DRX inactive duration, if one or more communication occasions 312 (e.g., RACH occasion(s) and/or PUSCH occasions for 2-step RACH) occur, are scheduled, and/or are permitted, a network entity and/or a UE may determine a period 314. In some examples, the period 314 (e.g., opportunistically active DTX and/or DRX duration) may be based on any communication with (e.g., transmission to and/or reception from) the network of which the UE has an indication. In some examples, one or more limitations may apply to the UE transmission and/or reception in the period 314 (e.g., opportunistically active duration), such as one or more resources available for reception and/or transmission.

In some examples, the period 314 may include the time of the one or more communication occasions 312 with a first time offset 316 and/or a second time offset 318 (e.g., a communication occasion plus or minus one or more RRC-configured offsets in each direction in time). In some approaches, the period 314 may be referred to as an active cell DTX and/or cell DRX period, which may be extended based on one or more time offsets. For instance, the period 314 may be a DRX active period based on random access (e.g., RACH) and/or SIB activities.

In some examples, one or more UEs (e.g., UE(s) 115) that perform RACH procedures and/or receive SIBs in the inactive communication period 310 (e.g., the duration of cell DTX and/or DRX) may also perform one or more configured communications, transmissions, and/or receptions during the communication occasion 312 (with the first offset 316 and/or the second offset 318) when the network entity 105 is awake for the RACH procedure(s) and/or SIB communication(s). The network entity 105 and/or the UE 115 may engage in one or more restricted communications during the period 314. For example, the one or more configuration communications, transmissions, and/or receptions may include one or more of the second message types described with reference to FIG. 2. In some examples, one or more UEs 115 may retain one or more periodic communication occasions (e.g., one or more SR occasions and/or CG occasions, among other examples) during the period 314 when the network entity 105 is active during the inactive communication period (e.g., during the cell DRX inactive).

FIG. 4 shows an example of a timing diagram 400 that supports communications during cell inactive communication periods in accordance with one or more aspects of the present disclosure. The timing diagram 400 illustrates a first timeline 402 showing a first active communication period 406, a second active communication period 408, and an inactive communication period 410. The first active communication period 406 and the second active communication period 408 may be identified as active based on a configuration (e.g., a configuration from a network entity 105). As illustrated in FIG. 4, the inactive communication period 410 includes a period 414 that may be determined for communications based on network activity (e.g., one or more communication occasions), as described with reference to one or more of FIGS. 2 and 3.

As illustrated in FIG. 4, a gap 416 may occur between the first active communication period 406 and the period 414. In a case that a duration or length of the gap 416 satisfies a threshold (e.g., if the gap 416 duration is less than an RRC configured threshold), a network entity 105 and/or a UE 115 may determine to extend 412 the first active communication period 406 into the inactive communication period 410 as illustrated in the second timeline 404. For example, in a case that at least a portion of the inactive communication period 410 (e.g., cell DRX inactive time) is changed to active time based on initial access activities or other activities as described with reference to FIG. 2 and/or FIG. 3, and the gap 416 between the period 414 (e.g., a conditionally active duration) and the first active communication period 406 is below an RRC-configured threshold, the UE 115 may extend 412 (e.g., bridge) the first active communication period 406 and the period 414 to form one active duration or period. In some examples, the extension of a cell DTX and/or DRX active duration may be based on one or more random access (e.g., RACH) procedures and/or SIB activities. An extension approach may be useful when the time gap 416 is relatively smaller than a gap that would be useful for energy saving.

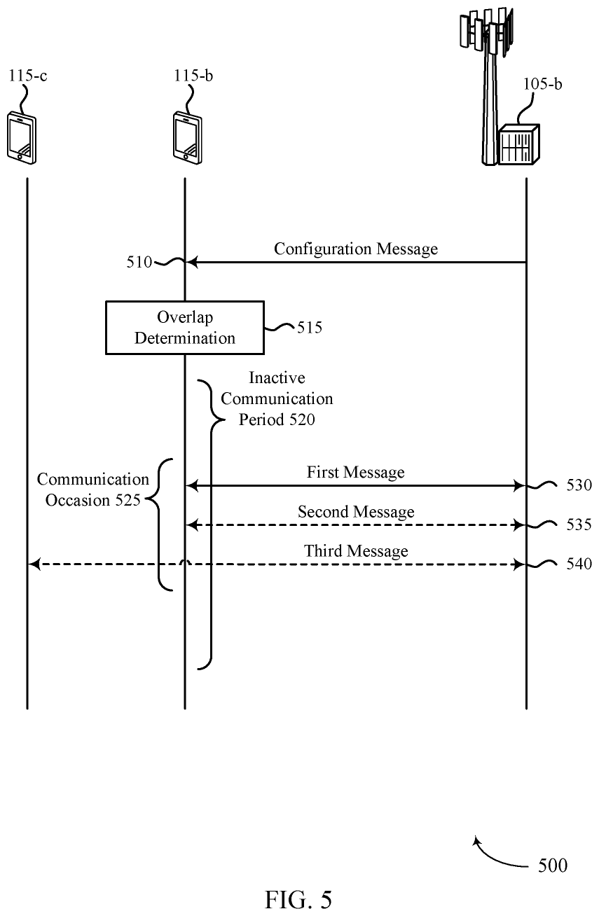

FIG. 5 shows an example of a process flow 500 that supports communications during cell inactive communication periods in accordance with one or more aspects of the present disclosure. The process flow 500 may include a UE 115-b and a UE 115-c which may be examples of the UE 115, as described herein. The process flow 500 may also include a network entity 105-b, which may be an example of the network entity 105, as described herein.

In the following description of the process flow 500, the operations between the network entity 105-b, the UE 115-b, and the UE 115-c may be transmitted in a different order than the example order shown, or the operations performed by the network entity 105-b, the UE 115-b, and the UE 115-c may be performed in different orders or at different times. Some operations may also be omitted from the process flow 500, and other operations may be added to the process flow 500. Further, although some operations or signaling may be shown to occur at different times for discussion purposes, these operations may actually occur at the same time or in overlapping time periods.

At 510, the network entity 105-b may transmit a configuration message to the UE 115-b. For example, the network entity 105-b may transmit (and the UE 115-b may receive) a configuration message as described with reference to FIG. 2. The configuration message may indicate a discontinuous configuration for restricting communication by the network entity 105-b during an inactive communication period 520.

At 515, the UE 115-b may perform an overlap determination. For example, the UE 115-b may determine that a communication occasion 525 overlaps with at least one inactive communication period 520 as described with reference to FIG. 2. For instance, a communication occasion 525 may be scheduled and/or permitted during the inactive communication period 520. In some examples, the UE 115-b may be scheduled (by the network entity 105-b, for instance) to communicate (e.g., transmit and/or receive) a second message and/or the UE 115-b may be configured (by the network entity 105-b, for instance) with a schedule that permits sending a random access (e.g., RACH) message during the communication occasion 525. In some examples, the UE 115-b may be configured (by the network entity 105-b, for instance) with a schedule indicating that another UE 115-c is scheduled to communicate with the network entity 105-b during the communication occasion 525 and/or that permits another UE 115-c to send a random access (e.g., RACH) message during the communication occasion 525. The UE 115-b may determine that the communication occasion 525 at least partially overlaps with the inactive communication period 520. In some examples, the UE 115-b and/or the network entity 105-b may deactivate one or more communication circuitries during the inactive communication period 520, except to active the one or more communication circuitries during the communication occasion 525.

At 530, the UE 115-b may communicate a first message during the inactive communication period 520. The first message may have a second message type that is restricted in the one or more inactive communication periods. For example, the UE 115-b may transmit and/or receive a message of a second message type that is restricted as described with reference to FIG. 2.

At 535, the UE 115-b may optionally communicate a second message with the network entity 105-b during the communication occasion 525. The second message may have a first message type that is permitted during the inactive communication period 520 as described with reference to FIG. 2. For example, the second message may be a RACH message and/or one or more SIBs.

At 540, the UE 115-c may optionally communicate a third message with the network entity 105-b during the communication occasion 525. The third message may have a first message type that is permitted during the inactive communication period as described with reference to FIG. 2. For example, the third message may be a RACH message and/or one or more SIBs.

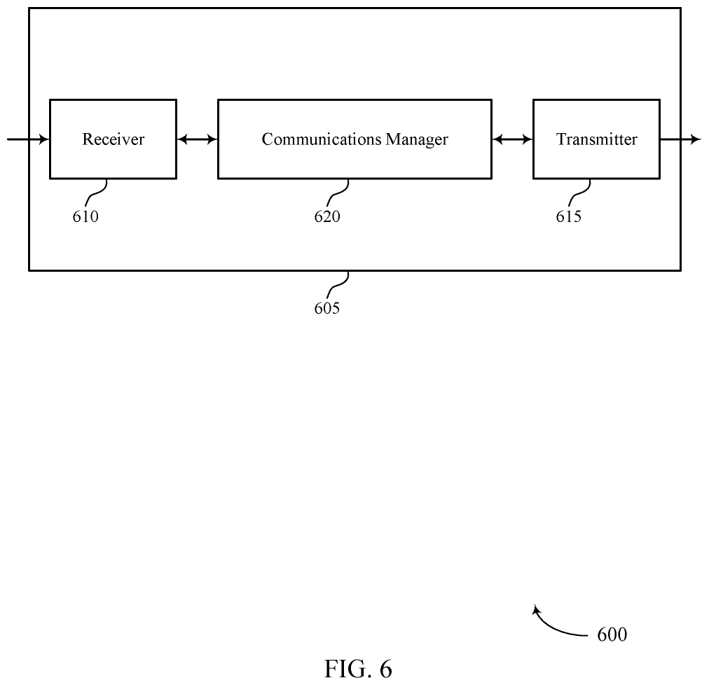

FIG. 6 shows a block diagram 600 of a device 605 that supports communications during cell inactive communication periods in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, and the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to communications during cell inactive communication periods). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to communications during cell inactive communication periods). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of communications during cell inactive communication periods as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor. If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

For example, the communications manager 620 is capable of, configured to, or operable to support a means for receiving, from a network entity, a message indicating a discontinuous communication configuration for restricting communication by the network entity during one or more inactive communication periods. The communications manager 620 is capable of, configured to, or operable to support a means for determining that a communication occasion overlaps with at least one inactive communication period of the one or more inactive communication periods, the communication occasion being associated with a first message type that is permitted in the one or more inactive communication periods. The communications manager 620 is capable of, configured to, or operable to support a means for communicating, with the network entity, a first message during the at least one inactive communication period, the first message having a second message type that is restricted in the one or more inactive communication periods.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources. For example, the device 605 may opportunistically utilize communication resources when the communication resources are available.

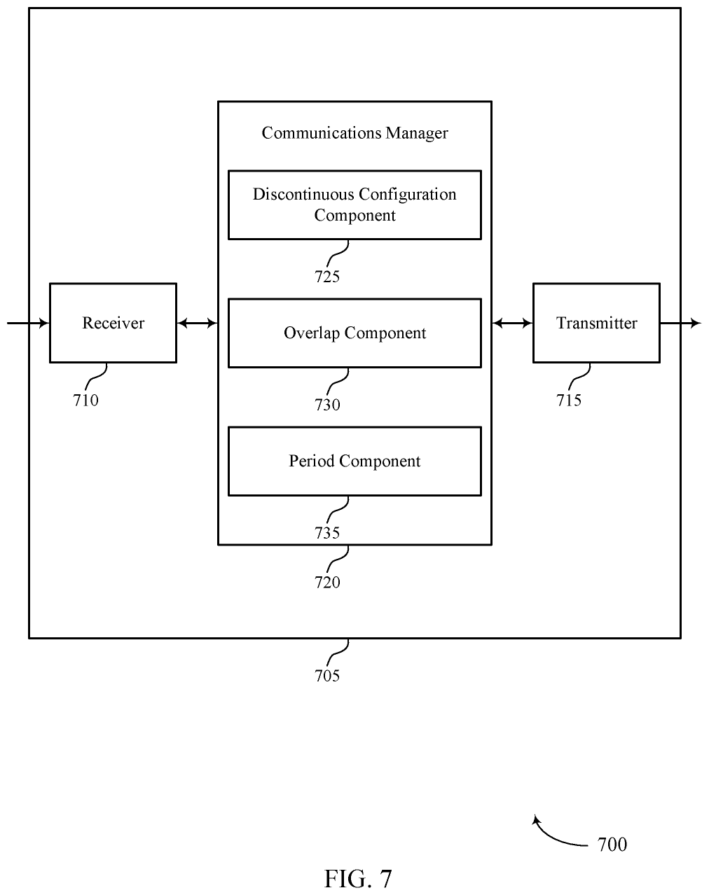

FIG. 7 shows a block diagram 700 of a device 705 that supports communications during cell inactive communication periods in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to communications during cell inactive communication periods). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to communications during cell inactive communication periods). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of communications during cell inactive communication periods as described herein. For example, the communications manager 720 may include a discontinuous configuration component 725, an overlap component 730, a period component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The discontinuous configuration component 725 is capable of, configured to, or operable to support a means for receiving, from a network entity, a message indicating a discontinuous communication configuration for restricting communication by the network entity during one or more inactive communication periods. The overlap component 730 is capable of, configured to, or operable to support a means for determining that a communication occasion overlaps with at least one inactive communication period of the one or more inactive communication periods, the communication occasion being associated with a first message type that is permitted in the one or more inactive communication periods. The period component 735 is capable of, configured to, or operable to support a means for communicating, with the network entity, a first message during the at least one inactive communication period, the first message having a second message type that is restricted in the one or more inactive communication periods.

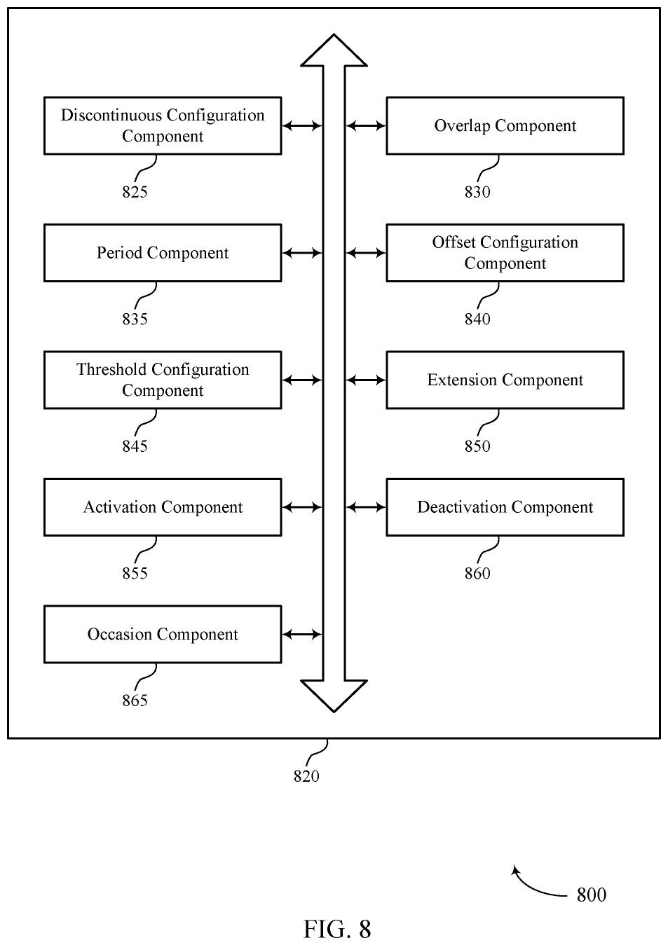

FIG. 8 shows a block diagram 800 of a communications manager 820 that supports communications during cell inactive communication periods in accordance with one or more aspects of the present disclosure. The communications manager 820 may be an example of aspects of a communications manager 620, a communications manager 720, or both, as described herein. The communications manager 820, or various components thereof, may be an example of means for performing various aspects of communications during cell inactive communication periods as described herein. For example, the communications manager 820 may include a discontinuous configuration component 825, an overlap component 830, a period component 835, an offset configuration component 840, a threshold configuration component 845, an extension component 850, an activation component 855, a deactivation component 860, an occasion component 865, or any combination thereof. Each of these components, or components or subcomponents thereof (e.g., one or more processors, one or more memories), may communicate, directly or indirectly, with one another (e.g., via one or more buses).

The discontinuous configuration component 825 is capable of, configured to, or operable to support a means for receiving, from a network entity, a message indicating a discontinuous communication configuration for restricting communication by the network entity during one or more inactive communication periods. The overlap component 830 is capable of, configured to, or operable to support a means for determining that a communication occasion overlaps with at least one inactive communication period of the one or more inactive communication periods, the communication occasion being associated with a first message type that is permitted in the one or more inactive communication periods. The period component 835 is capable of, configured to, or operable to support a means for communicating, with the network entity, a first message during the at least one inactive communication period, the first message having a second message type that is restricted in the one or more inactive communication periods.

In some examples, the offset configuration component 840 is capable of, configured to, or operable to support a means for receiving, from the network entity, a control message indicating a configuration of one or more time offsets relative to the communication occasion, where the first message is communicated within a period including the communication occasion and the one or more time offsets and during the at least one inactive communication period.

In some examples, the threshold configuration component 845 is capable of, configured to, or operable to support a means for receiving, from the network entity, a control message indicating a configuration of a threshold for determining whether one or more active communication periods of the discontinuous communication configuration are extended into at least a portion of the one or more inactive communication periods. In some examples, the extension component 850 is capable of, configured to, or operable to support a means for determining that a duration between a first active communication period of the one or more active communication periods and the communication occasion satisfies the threshold, where the first message is communicated within a period including the communication occasion and an extension of the first active communication period into the duration in response to the determination.

In some examples, the activation component 855 is capable of, configured to, or operable to support a means for activating one or more communication circuitries during at least a portion of the communication occasion that is during the at least one inactive communication period. In some examples, the deactivation component 860 is capable of, configured to, or operable to support a means for deactivating the one or more communication circuitries during at least a portion of the at least one inactive communication period that is not during the communication occasion.

In some examples, the communication occasion that overlaps with the at least one inactive communication period is a first periodic communication occasion of a set of multiple periodic communication occasions. In some examples, the set of multiple periodic communication occasions includes a second periodic communication occasion that overlaps with at least one active communication period before the at least one inactive communication period.

In some examples, the occasion component 865 is capable of, configured to, or operable to support a means for communicating a second message of the first message type with the network entity during the communication occasion, where the second message includes a random access message, a system information message, or a combination thereof.

In some examples, the first message type that is permitted in the one or more inactive communication periods includes a random access message type and the communication occasion includes a random access occasion or a PUSCH occasion for transmitting one or more random access messages.

In some examples, the first message type that is permitted in the one or more inactive communication periods includes a system information message type and the communication occasion includes an occasion for receiving one or more system information messages.

In some examples, the first message type that is permitted in the one or more inactive communication periods includes a paging message type and the communication occasion includes a paging channel occasion for receiving one or more paging messages.

In some examples, the second message type includes a periodic channel state information-reference signal (CSI-RS) type, an SPS CSI-RS type, a TRS type, a PRS type, a physical downlink control channel message scrambled with a UE-specific RNTI type, a physical downlink control channel in a type 3 CSS message type, an SPS PDSCH message type, a SR message type, a periodic CSI report type, an SPS CSI report type, a periodic SRS type, an SPS SRS type, a CG PUSCH message type, a CG message type, a BSR message type, a PUCCH message type, or a combination thereof.

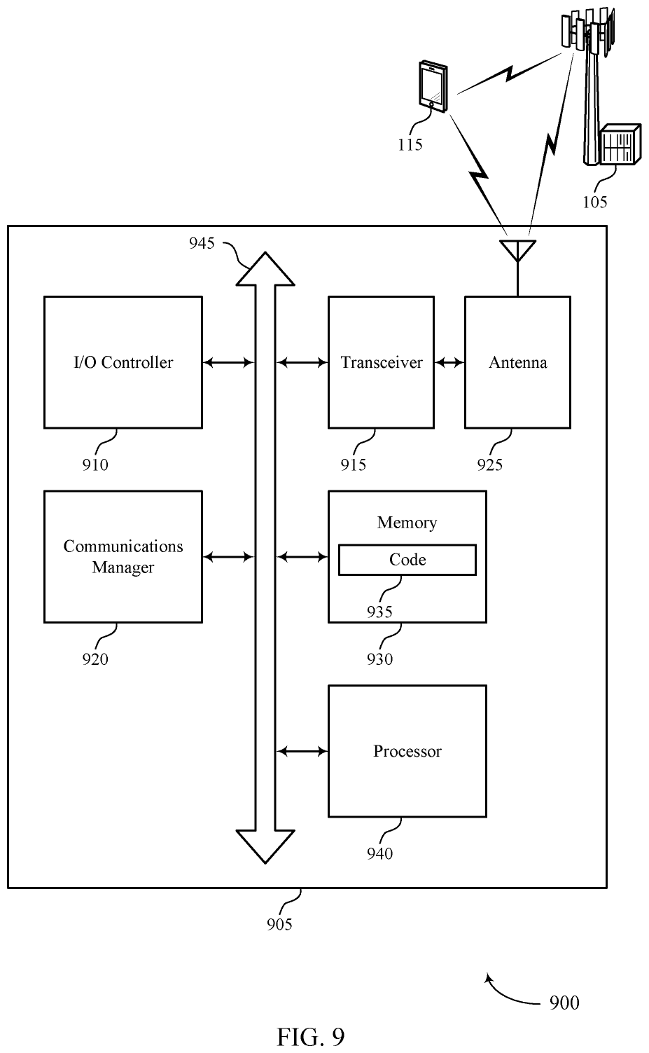

FIG. 9 shows a diagram of a system 900 including a device 905 that supports communications during cell inactive communication periods in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable code 935 including instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may contain, among other things, a basic I/O system (BIOS) which may control basic hardware or software operation such as the interaction with peripheral components or devices.

The at least one processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting communications during cell inactive communication periods). For example, the device 905 or a component of the device 905 may include at least one processor 940 and at least one memory 930 coupled with or to the at least one processor 940, the at least one processor 940 and at least one memory 930 configured to perform various functions described herein. In some examples, the at least one processor 940 may include multiple processors and the at least one memory 930 may include multiple memories. One or more of the multiple processors may be coupled with one or more of the multiple memories, which may, individually or collectively, be configured to perform various functions herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. As such, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code stored in the at least one memory 930 or otherwise, to perform one or more of the functions described herein.

For example, the communications manager 920 is capable of, configured to, or operable to support a means for receiving, from a network entity, a message indicating a discontinuous communication configuration for restricting communication by the network entity during one or more inactive communication periods. The communications manager 920 is capable of, configured to, or operable to support a means for determining that a communication occasion overlaps with at least one inactive communication period of the one or more inactive communication periods, the communication occasion being associated with a first message type that is permitted in the one or more inactive communication periods. The communications manager 920 is capable of, configured to, or operable to support a means for communicating, with the network entity, a first message during the at least one inactive communication period, the first message having a second message type that is restricted in the one or more inactive communication periods.

By including or configuring the communications manager 920 in accordance with examples as described herein, the device 905 may support techniques for improved communication reliability, reduced latency, more efficient utilization of communication resources, improved coordination between devices, and/or improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of communications during cell inactive communication periods as described herein, or the at least one processor 940 and the at least one memory 930 may be otherwise configured to, individually or collectively, perform or support such operations.

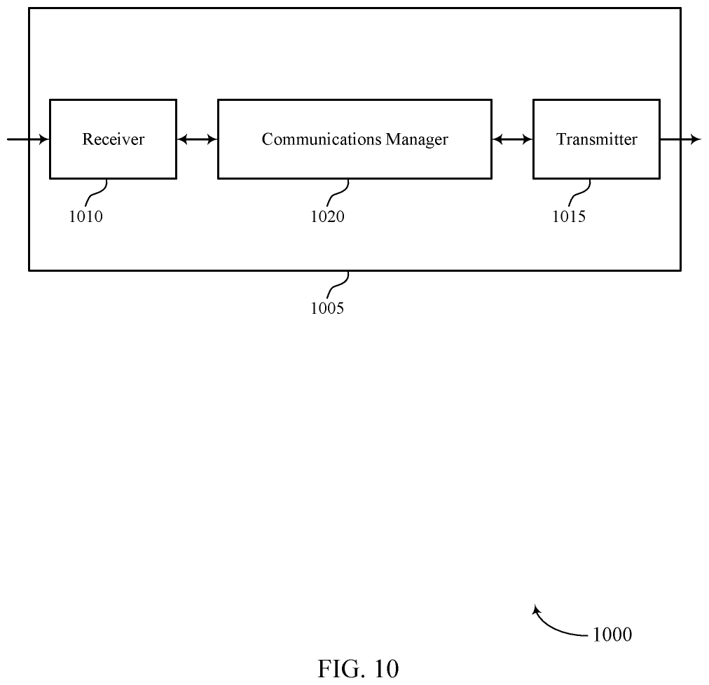

FIG. 10 shows a block diagram 1000 of a device 1005 that supports communications during cell inactive communication periods in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of communications during cell inactive communication periods as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor. If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

For example, the communications manager 1020 is capable of, configured to, or operable to support a means for transmitting, to a UE, a message indicating a discontinuous communication configuration for restricting communication by the network entity during one or more inactive communication periods. The communications manager 1020 is capable of, configured to, or operable to support a means for determining that a communication occasion overlaps with at least one inactive communication period of the one or more inactive communication periods, the communication occasion being associated with a first message type that is permitted in the one or more inactive communication periods. The communications manager 1020 is capable of, configured to, or operable to support a means for communicating, with the UE, a first message during at least one inactive communication period, the first message having a second message type that is restricted in the one or more inactive communication periods.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources. For example, the device 1005 may opportunistically utilize communication resources when the communication resources are available.

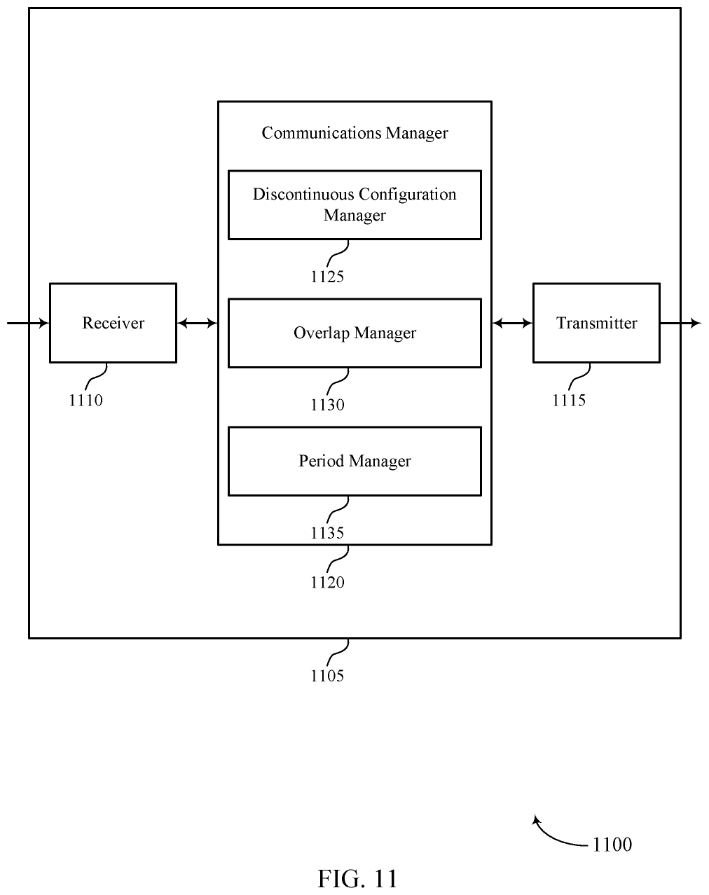

FIG. 11 shows a block diagram 1100 of a device 1105 that supports communications during cell inactive communication periods in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, and the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of communications during cell inactive communication periods as described herein. For example, the communications manager 1120 may include a discontinuous configuration manager 1125, an overlap manager 1130, a period manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The discontinuous configuration manager 1125 is capable of, configured to, or operable to support a means for transmitting, to a UE, a message indicating a discontinuous communication configuration for restricting communication by the network entity during one or more inactive communication periods. The overlap manager 1130 is capable of, configured to, or operable to support a means for determining that a communication occasion overlaps with at least one inactive communication period of the one or more inactive communication periods, the communication occasion being associated with a first message type that is permitted in the one or more inactive communication periods. The period manager 1135 is capable of, configured to, or operable to support a means for communicating, with the UE, a first message during at least one inactive communication period, the first message having a second message type that is restricted in the one or more inactive communication periods.

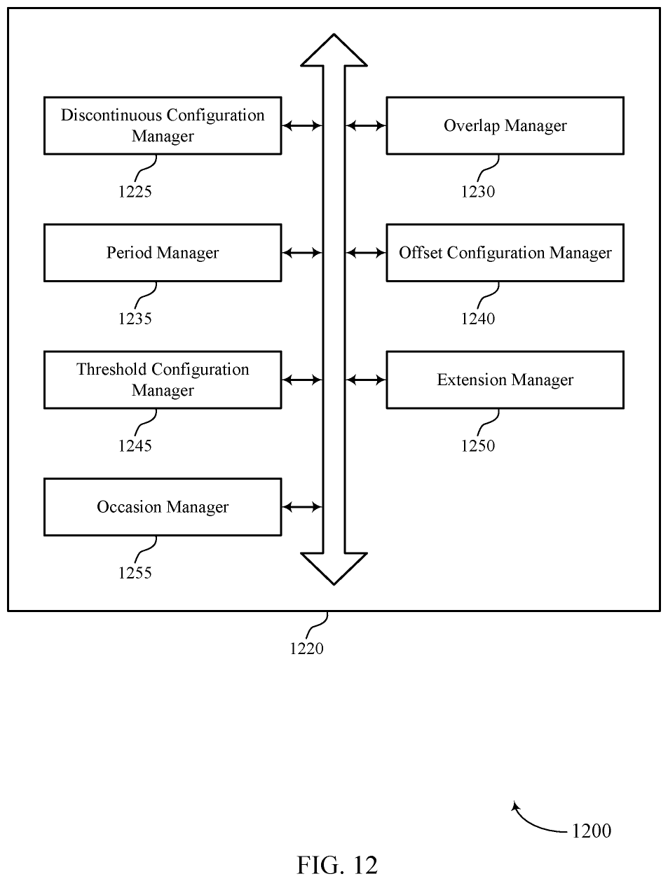

FIG. 12 shows a block diagram 1200 of a communications manager 1220 that supports communications during cell inactive communication periods in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of communications during cell inactive communication periods as described herein. For example, the communications manager 1220 may include a discontinuous configuration manager 1225, an overlap manager 1230, a period manager 1235, an offset configuration manager 1240, a threshold configuration manager 1245, an extension manager 1250, an occasion manager 1255, or any combination thereof. Each of these components, or components or subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The discontinuous configuration manager 1225 is capable of, configured to, or operable to support a means for transmitting, to a UE, a message indicating a discontinuous communication configuration for restricting communication by the network entity during one or more inactive communication periods. The overlap manager 1230 is capable of, configured to, or operable to support a means for determining that a communication occasion overlaps with at least one inactive communication period of the one or more inactive communication periods, the communication occasion being associated with a first message type that is permitted in the one or more inactive communication periods. The period manager 1235 is capable of, configured to, or operable to support a means for communicating, with the UE, a first message during at least one inactive communication period, the first message having a second message type that is restricted in the one or more inactive communication periods.

In some examples, the offset configuration manager 1240 is capable of, configured to, or operable to support a means for transmitting, to the UE, a control message indicating a configuration of one or more time offsets relative to the communication occasion, where the first message is communicated within a period including the communication occasion and the one or more time offsets and during the at least one inactive communication period.

In some examples, the threshold configuration manager 1245 is capable of, configured to, or operable to support a means for transmitting, to the UE, a control message indicating a configuration of a threshold for determining whether one or more active communication periods of the discontinuous communication configuration are extended into at least a portion of the one or more inactive communication periods. In some examples, the extension manager 1250 is capable of, configured to, or operable to support a means for determining that a duration between a first active communication period of the one or more active communication periods and the communication occasion satisfies the threshold, where the first message is communicated within a period including the communication occasion and an extension of the first active communication period into the duration in response to the determination.

In some examples, the communication occasion that overlaps with the at least one inactive communication period is a first periodic communication occasion of a set of multiple periodic communication occasions. In some examples, the set of multiple periodic communication occasions includes a second periodic communication occasion that overlaps with at least one active communication period before the at least one inactive communication period.

In some examples, the occasion manager 1255 is capable of, configured to, or operable to support a means for communicating a second message of the first message type with the UE during the communication occasion, where the second message includes a random access message, a system information message, or a combination thereof.

In some examples, the first message type that is permitted in the one or more inactive communication periods includes a random access message type and the communication occasion includes a random access occasion or a PUSCH occasion for receiving one or more random access messages.

In some examples, the first message type that is permitted in the one or more inactive communication periods includes a system information message type and the communication occasion includes an occasion for transmitting one or more system information messages.

In some examples, the first message type that is permitted in the one or more inactive communication periods includes a paging message type and the communication occasion includes a paging channel occasion for transmitting one or more paging messages.

In some examples, the second message type includes a periodic CSI-RS type, an SPS CSI-RS type, a TRS type, a PRS type, a physical downlink control channel message scrambled with a UE-specific RNTI type, a physical downlink control channel in a type 3 CSS message type, an SPS PDSCH message type, a SR message type, a periodic CSI report type, an SPS CSI report type, a periodic SRS type, an SPS SRS type, a CG PUSCH message type, a CG message type, a BSR message type, a PUCCH message type, or a combination thereof.

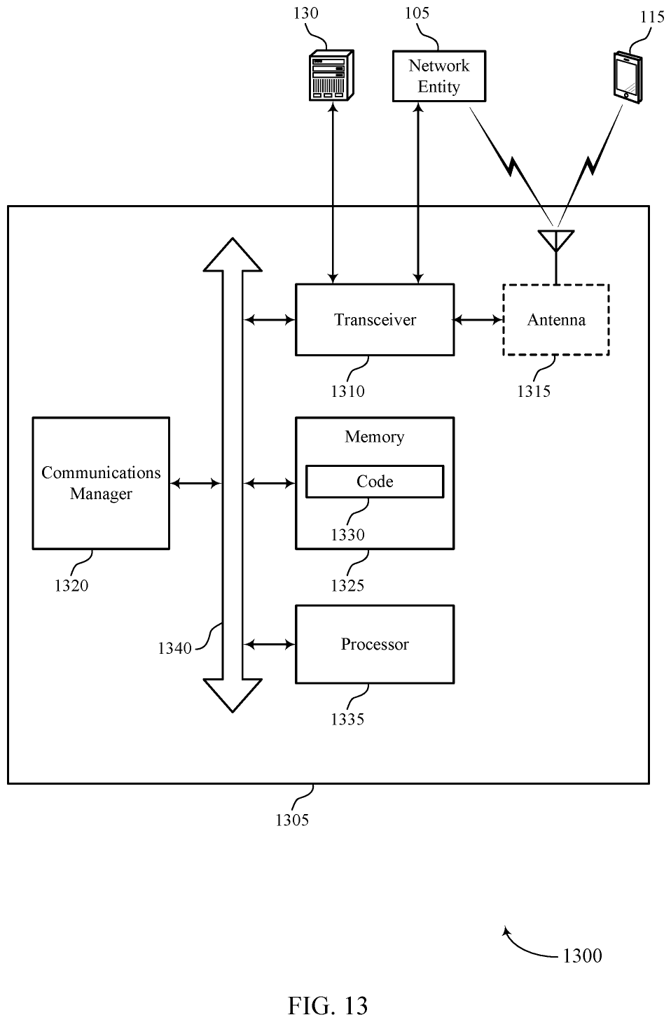

FIG. 13 shows a diagram of a system 1300 including a device 1305 that supports communications during cell inactive communication periods in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., a communication link 125, a backhaul communication link 120, a midhaul communication link 162, a fronthaul communication link 168).

The at least one memory 1325 may include RAM, ROM, or any combination thereof. The at least one memory 1325 may store computer-readable, computer-executable code 1330 including instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may contain, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting communications during cell inactive communication periods). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325). In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. As such, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

For example, the communications manager 1320 is capable of, configured to, or operable to support a means for transmitting, to a UE, a message indicating a discontinuous communication configuration for restricting communication by the network entity during one or more inactive communication periods. The communications manager 1320 is capable of, configured to, or operable to support a means for determining that a communication occasion overlaps with at least one inactive communication period of the one or more inactive communication periods, the communication occasion being associated with a first message type that is permitted in the one or more inactive communication periods. The communications manager 1320 is capable of, configured to, or operable to support a means for communicating, with the UE, a first message during at least one inactive communication period, the first message having a second message type that is restricted in the one or more inactive communication periods.

By including or configuring the communications manager 1320 in accordance with examples as described herein, the device 1305 may support techniques for improved communication reliability, reduced latency, more efficient utilization of communication resources, improved coordination between devices, and/or improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of communications during cell inactive communication periods as described herein, or the at least one processor 1335 and the at least one memory 1325 may be otherwise configured to, individually or collectively, perform or support such operations.

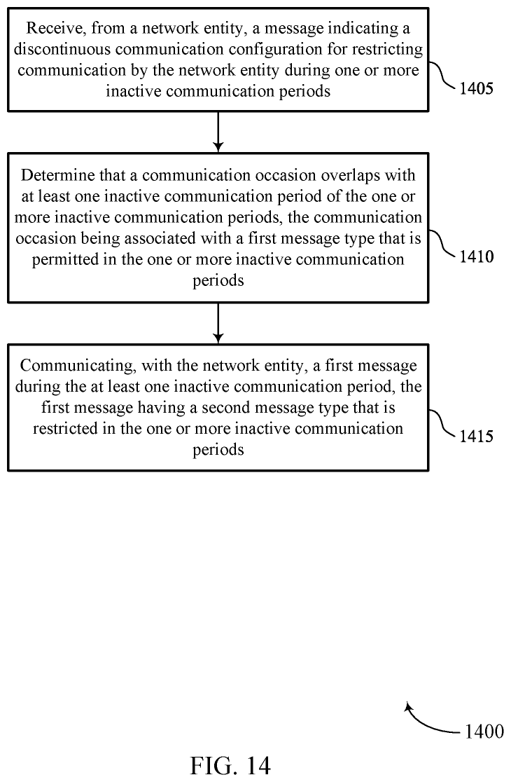

FIG. 14 shows a flowchart illustrating a method 1400 that supports communications during cell inactive communication periods in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a network entity, a message indicating a discontinuous communication configuration for restricting communication by the network entity during one or more inactive communication periods. The operations of 1405 may be performed in accordance with examples as disclosed herein. In some examples, aspects of the operations of 1405 may be performed by a discontinuous configuration component 825 as described with reference to FIG. 8.

At 1410, the method may include determining that a communication occasion overlaps with at least one inactive communication period of the one or more inactive communication periods, the communication occasion being associated with a first message type that is permitted in the one or more inactive communication periods. The operations of 1410 may be performed in accordance with examples as disclosed herein. In some examples, aspects of the operations of 1410 may be performed by an overlap component 830 as described with reference to FIG. 8.

At 1415, the method may include communicating, with the network entity, a first message during the at least one inactive communication period, the first message having a second message type that is restricted in the one or more inactive communication periods. The operations of 1415 may be performed in accordance with examples as disclosed herein. In some examples, aspects of the operations of 1415 may be performed by a period component 835 as described with reference to FIG. 8.

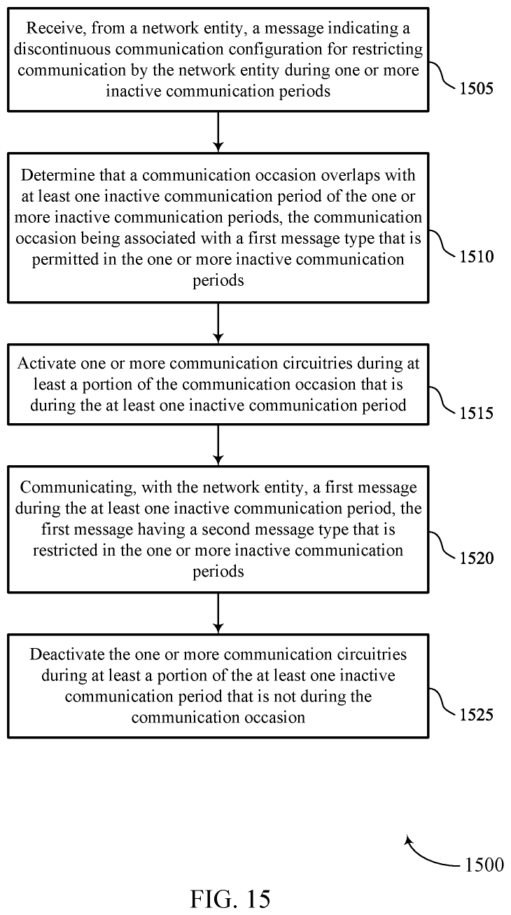

FIG. 15 shows a flowchart illustrating a method 1500 that supports communications during cell inactive communication periods in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, a message indicating a discontinuous communication configuration for restricting communication by the network entity during one or more inactive communication periods. The operations of 1505 may be performed in accordance with examples as disclosed herein. In some examples, aspects of the operations of 1505 may be performed by a discontinuous configuration component 825 as described with reference to FIG. 8.

At 1510, the method may include determining that a communication occasion overlaps with at least one inactive communication period of the one or more inactive communication periods, the communication occasion being associated with a first message type that is permitted in the one or more inactive communication periods. The operations of 1510 may be performed in accordance with examples as disclosed herein. In some examples, aspects of the operations of 1510 may be performed by an overlap component 830 as described with reference to FIG. 8.

At 1515, the method may include activating one or more communication circuitries during at least a portion of the communication occasion that is during the at least one inactive communication period. The operations of 1515 may be performed in accordance with examples as disclosed herein. In some examples, aspects of the operations of 1515 may be performed by an activation component 855 as described with reference to FIG. 8.

At 1520, the method may include communicating, with the network entity, a first message during the at least one inactive communication period, the first message having a second message type that is restricted in the one or more inactive communication periods. The operations of 1520 may be performed in accordance with examples as disclosed herein. In some examples, aspects of the operations of 1520 may be performed by a period component 835 as described with reference to FIG. 8.

At 1525, the method may include deactivating the one or more communication circuitries during at least a portion of the at least one inactive communication period that is not during the communication occasion. The operations of 1525 may be performed in accordance with examples as disclosed herein. In some examples, aspects of the operations of 1525 may be performed by a deactivation component 860 as described with reference to FIG. 8.

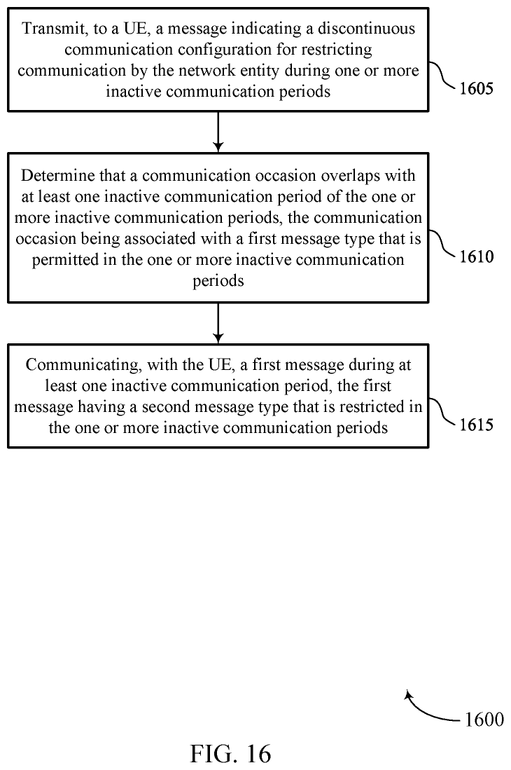

FIG. 16 shows a flowchart illustrating a method 1600 that supports communications during cell inactive communication periods in accordance with aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1605, the method may include transmitting, to a UE, a message indicating a discontinuous communication configuration for restricting communication by the network entity during one or more inactive communication periods. The operations of 1605 may be performed in accordance with examples as disclosed herein. In some examples, aspects of the operations of 1605 may be performed by a discontinuous configuration manager 1225 as described with reference to FIG. 12.

At 1610, the method may include determining that a communication occasion overlaps with at least one inactive communication period of the one or more inactive communication periods, the communication occasion being associated with a first message type that is permitted in the one or more inactive communication periods. The operations of 1610 may be performed in accordance with examples as disclosed herein. In some examples, aspects of the operations of 1610 may be performed by an overlap manager 1230 as described with reference to FIG. 12.

At 1615, the method may include communicating, with the UE, a first message during at least one inactive communication period, the first message having a second message type that is restricted in the one or more inactive communication periods. The operations of 1615 may be performed in accordance with examples as disclosed herein. In some examples, aspects of the operations of 1615 may be performed by a period manager 1235 as described with reference to FIG. 12.

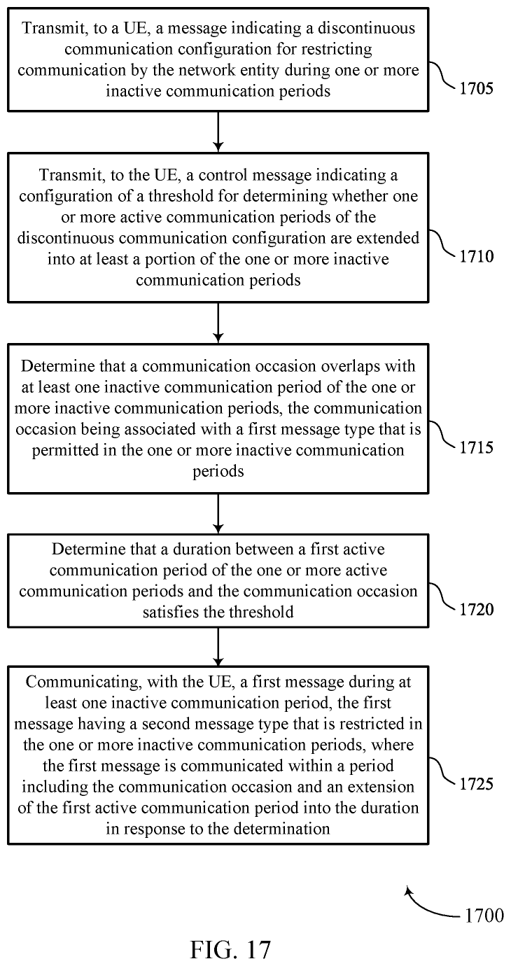

FIG. 17 shows a flowchart illustrating a method 1700 that supports communications during cell inactive communication periods in accordance with aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include transmitting, to a UE, a message indicating a discontinuous communication configuration for restricting communication by the network entity during one or more inactive communication periods. The operations of 1705 may be performed in accordance with examples as disclosed herein. In some examples, aspects of the operations of 1705 may be performed by a discontinuous configuration manager 1225 as described with reference to FIG. 12.

At 1710, the method may include transmitting, to the UE, a control message indicating a configuration of a threshold for determining whether one or more active communication periods of the discontinuous communication configuration are extended into at least a portion of the one or more inactive communication periods. The operations of 1710 may be performed in accordance with examples as disclosed herein. In some examples, aspects of the operations of 1710 may be performed by a threshold configuration manager 1245 as described with reference to FIG. 12.

At 1715, the method may include determining that a communication occasion overlaps with at least one inactive communication period of the one or more inactive communication periods, the communication occasion being associated with a first message type that is permitted in the one or more inactive communication periods. The operations of 1715 may be performed in accordance with examples as disclosed herein. In some examples, aspects of the operations of 1715 may be performed by an overlap manager 1230 as described with reference to FIG. 12.

At 1720, the method may include determining that a duration between a first active communication period of the one or more active communication periods and the communication occasion satisfies the threshold. The operations of 1720 may be performed in accordance with examples as disclosed herein. In some examples, aspects of the operations of 1720 may be performed by an extension manager 1250 as described with reference to FIG. 12.

At 1725, the method may include communicating, with the UE, a first message during at least one inactive communication period, the first message having a second message type that is restricted in the one or more inactive communication periods, where the first message is communicated within a period including the communication occasion and an extension of the first active communication period into the duration in response to the determination. The operations of 1725 may be performed in accordance with examples as disclosed herein. In some examples, aspects of the operations of 1725 may be performed by a period manager 1235 as described with reference to FIG. 12.

The following provides an overview of aspects of the present disclosure:

Aspect 1: A method for wireless communications by a UE, comprising: receiving, from a network entity, a message indicating a discontinuous communication configuration for restricting communication by the network entity during one or more inactive communication periods; determining that a communication occasion overlaps with at least one inactive communication period of the one or more inactive communication periods, the communication occasion being associated with a first message type that is permitted in the one or more inactive communication periods; and communicating, with the network entity, a first message during the at least one inactive communication period, the first message having a second message type that is restricted in the one or more inactive communication periods.

Aspect 2: The method of aspect 1, further comprising: receiving, from the network entity, a control message indicating a configuration of one or more time offsets relative to the communication occasion, wherein the first message is communicated within a period including the communication occasion and the one or more time offsets and during the at least one inactive communication period.

Aspect 3: The method of any of aspects 1 through 2, further comprising: receiving, from the network entity, a control message indicating a configuration of a threshold for determining whether one or more active communication periods of the discontinuous communication configuration are extended into at least a portion of the one or more inactive communication periods; and determining that a duration between a first active communication period of the one or more active communication periods and the communication occasion satisfies the threshold, wherein the first message is communicated within a period including the communication occasion and an extension of the first active communication period into the duration in response to the determination.

Aspect 4: The method of any of aspects 1 through 3, further comprising: activating one or more communication circuitries during at least a portion of the communication occasion that is during the at least one inactive communication period; and deactivating the one or more communication circuitries during at least a portion of the at least one inactive communication period that is not during the communication occasion.

Aspect 5: The method of any of aspects 1 through 4, wherein the communication occasion that overlaps with the at least one inactive communication period is a first periodic communication occasion of a plurality of periodic communication occasions, and the plurality of periodic communication occasions comprises a second periodic communication occasion that overlaps with at least one active communication period before the at least one inactive communication period.

Aspect 6: The method of any of aspects 1 through 5, further comprising: communicating a second message of the first message type with the network entity during the communication occasion, wherein the second message comprises a random access message, a system information message, or a combination thereof.

Aspect 7: The method of any of aspects 1 through 6, wherein the first message type that is permitted in the one or more inactive communication periods comprises a random access message type and the communication occasion comprises a random access occasion or a PUSCH occasion for transmitting one or more random access messages.

Aspect 8: The method of any of aspects 1 through 7, wherein the first message type that is permitted in the one or more inactive communication periods comprises a system information message type and the communication occasion comprises an occasion for receiving one or more system information messages.

Aspect 9: The method of any of aspects 1 through 8, wherein the first message type that is permitted in the one or more inactive communication periods comprises a paging message type and the communication occasion comprises a paging channel occasion for receiving one or more paging messages.

Aspect 10: The method of any of aspects 1 through 9, wherein the second message type comprises a periodic CSI-RS type, an SPS CSI-RS type, a TRS type, a PRS type, a physical downlink control channel message scrambled with a UE-specific RNTI type, a physical downlink control channel in a type 3 CSS message type, an SPS PDSCH message type, a SR message type, a periodic CSI report type, an SPS CSI report type, a periodic SRS type, an SPS SRS type, a CG PUSCH message type, a CG message type, a BSR message type, a PUCCH message type, or a combination thereof.

Aspect 11: A method for wireless communications by a network entity, comprising: transmitting, to a UE, a message indicating a discontinuous communication configuration for restricting communication by the network entity during one or more inactive communication periods; determining that a communication occasion overlaps with at least one inactive communication period of the one or more inactive communication periods, the communication occasion being associated with a first message type that is permitted in the one or more inactive communication periods; and communicating, with the UE, a first message during at least one inactive communication period, the first message having a second message type that is restricted in the one or more inactive communication periods.

Aspect 12: The method of aspect 11, further comprising: transmitting, to the UE, a control message indicating a configuration of one or more time offsets relative to the communication occasion, wherein the first message is communicated within a period including the communication occasion and the one or more time offsets and during the at least one inactive communication period.

Aspect 13: The method of any of aspects 11 through 12, further comprising: transmitting, to the UE, a control message indicating a configuration of a threshold for determining whether one or more active communication periods of the discontinuous communication configuration are extended into at least a portion of the one or more inactive communication periods; and determining that a duration between a first active communication period of the one or more active communication periods and the communication occasion satisfies the threshold, wherein the first message is communicated within a period including the communication occasion and an extension of the first active communication period into the duration in response to the determination.

Aspect 14: The method of any of aspects 11 through 13, wherein the communication occasion that overlaps with the at least one inactive communication period is a first periodic communication occasion of a plurality of periodic communication occasions, and the plurality of periodic communication occasions comprises a second periodic communication occasion that overlaps with at least one active communication period before the at least one inactive communication period.

Aspect 15: The method of any of aspects 11 through 14, further comprising: communicating a second message of the first message type with the UE during the communication occasion, wherein the second message comprises a random access message, a system information message, or a combination thereof.

Aspect 16: The method of any of aspects 11 through 15, wherein the first message type that is permitted in the one or more inactive communication periods comprises a random access message type and the communication occasion comprises a random access occasion or a PUSCH occasion for receiving one or more random access messages.

Aspect 17: The method of any of aspects 11 through 16, wherein the first message type that is permitted in the one or more inactive communication periods comprises a system information message type and the communication occasion comprises an occasion for transmitting one or more system information messages.

Aspect 18: The method of any of aspects 11 through 17, wherein the first message type that is permitted in the one or more inactive communication periods comprises a paging message type and the communication occasion comprises a paging channel occasion for transmitting one or more paging messages.

Aspect 19: The method of any of aspects 11 through 18, wherein the second message type comprises a periodic CSI-RS type, an SPS CSI-RS type, a TRS type, a PRS type, a physical downlink control channel message scrambled with a UE-specific RNTI type, a physical downlink control channel in a type 3 CSS message type, an SPS PDSCH message type, a SR message type, a periodic CSI report type, an SPS CSI report type, a periodic SRS type, an SPS SRS type, a CG PUSCH message type, a CG message type, a BSR message type, a PUCCH message type, or a combination thereof.

Aspect 20: A UE comprising one or more memories storing processor-executable code, and one or more processors coupled with the one or more memories and individually or collectively operable to execute the code to cause the UE to perform a method of any of aspects 1 through 10.

Aspect 21: A UE comprising at least one means for performing a method of any of aspects 1 through 10.

Aspect 22: A non-transitory computer-readable medium storing code the code comprising instructions executable by one or more processors to perform a method of any of aspects 1 through 10.

Aspect 23: A network entity comprising one or more memories storing processor-executable code, and one or more processors coupled with the one or more memories and individually or collectively operable to execute the code to cause the network entity to perform a method of any of aspects 11 through 19.

Aspect 24: A network entity comprising at least one means for performing a method of any of aspects 11 through 19.

Aspect 25: A non-transitory computer-readable medium storing code the code comprising instructions executable by one or more processors to perform a method of any of aspects 11 through 19.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a network entity, a message indicating a discontinuous communication configuration for restricting communication by the network entity during one or more inactive communication periods;
determine that a communication occasion overlaps with at least one inactive communication period of the one or more inactive communication periods, the communication occasion being associated with a first message type that is permitted in the one or more inactive communication periods; and
communicating, with the network entity, a first message during the at least one inactive communication period, the first message having a second message type that is restricted in the one or more inactive communication periods.

2. The UE of claim 1, wherein the one or more processors are individually or collectively further operable to execute the code to cause the UE to:
receive, from the network entity, a control message indicating a configuration of one or more time offsets relative to the communication occasion, wherein the first message is communicated within a period including the communication occasion and the one or more time offsets and during the at least one inactive communication period.

3. The UE of claim 1, wherein the one or more processors are individually or collectively further operable to execute the code to cause the UE to:
receive, from the network entity, a control message indicating a configuration of a threshold for determining whether one or more active communication periods of the discontinuous communication configuration are extended into at least a portion of the one or more inactive communication periods; and
determine that a duration between a first active communication period of the one or more active communication periods and the communication occasion satisfies the threshold, wherein the first message is communicated within a period including the communication occasion and an extension of the first active communication period into the duration in response to the determination.

4. The UE of claim 1, wherein the one or more processors are individually or collectively further operable to execute the code to cause the UE to:
activate one or more communication circuitries during at least a portion of the communication occasion that is during the at least one inactive communication period; and
deactivate the one or more communication circuitries during at least a portion of the at least one inactive communication period that is not during the communication occasion.

5. The UE of claim 1, wherein:
the communication occasion that overlaps with the at least one inactive communication period is a first periodic communication occasion of a plurality of periodic communication occasions, and
the plurality of periodic communication occasions comprises a second periodic communication occasion that overlaps with at least one active communication period before the at least one inactive communication period.

6. The UE of claim 1, wherein the one or more processors are individually or collectively further operable to execute the code to cause the UE to:
communicate a second message of the first message type with the network entity during the communication occasion, wherein the second message comprises a random access message, a system information message, or a combination thereof.

7. The UE of claim 1, wherein the first message type that is permitted in the one or more inactive communication periods comprises a random access message type and the communication occasion comprises a random access occasion or a physical uplink shared channel occasion for transmitting one or more random access messages.

8. The UE of claim 1, wherein the first message type that is permitted in the one or more inactive communication periods comprises a system information message type and the communication occasion comprises an occasion for receiving one or more system information messages.

9. The UE of claim 1, wherein the first message type that is permitted in the one or more inactive communication periods comprises a paging message type and the communication occasion comprises a paging channel occasion for receiving one or more paging messages.

10. The UE of claim 1, wherein the second message type comprises a periodic channel state information-reference signal type, a semi-persistent scheduling channel state information-reference signal type, a tracking reference signal type, a positioning reference signal type, a physical downlink control channel message scrambled with a UE-specific radio network temporary identifier type, a physical downlink control channel in a type 3 common search space message type, a semi-persistent scheduling physical downlink shared channel message type, a scheduling request message type, a periodic channel state information report type, a semi-persistent scheduling channel state information report type, a periodic sounding reference signal type, a semi-persistent scheduling sounding reference signal type, a configured grant physical uplink shared channel message type, a configured grant message type, a buffer status report message type, a physical uplink control channel message type, or a combination thereof.

11. A network entity, comprising:
one or more memories storing processor-executable code; and
one or more processors coupled with the one or more memories and individually or collectively operable to execute the code to cause the network entity to:
transmit, to a user equipment (UE), a message indicating a discontinuous communication configuration for restricting communication by the network entity during one or more inactive communication periods;
determine that a communication occasion overlaps with at least one inactive communication period of the one or more inactive communication periods, the communication occasion being associated with a first message type that is permitted in the one or more inactive communication periods; and
communicating, with the UE, a first message during at least one inactive communication period, the first message having a second message type that is restricted in the one or more inactive communication periods.

12. The network entity of claim 11, wherein the one or more processors are individually or collectively further operable to execute the code to cause the network entity to:
transmit, to the UE, a control message indicating a configuration of one or more time offsets relative to the communication occasion, wherein the first message is communicated within a period including the communication occasion and the one or more time offsets and during the at least one inactive communication period.

13. The network entity of claim 11, wherein the one or more processors are individually or collectively further operable to execute the code to cause the network entity to:
transmit, to the UE, a control message indicating a configuration of a threshold for determining whether one or more active communication periods of the discontinuous communication configuration are extended into at least a portion of the one or more inactive communication periods; and
determine that a duration between a first active communication period of the one or more active communication periods and the communication occasion satisfies the threshold, wherein the first message is communicated within a period including the communication occasion and an extension of the first active communication period into the duration in response to the determination.

14. The network entity of claim 11, wherein:
the communication occasion that overlaps with the at least one inactive communication period is a first periodic communication occasion of a plurality of periodic communication occasions, and
the plurality of periodic communication occasions comprises a second periodic communication occasion that overlaps with at least one active communication period before the at least one inactive communication period.

15. The network entity of claim 11, wherein the one or more processors are individually or collectively further operable to execute the code to cause the network entity to:
communicate a second message of the first message type with the UE during the communication occasion, wherein the second message comprises a random access message, a system information message, or a combination thereof.

16. The network entity of claim 11, wherein the first message type that is permitted in the one or more inactive communication periods comprises a random access message type and the communication occasion comprises a random access occasion or a physical uplink shared channel occasion for receiving one or more random access messages.

17. The network entity of claim 11, wherein the first message type that is permitted in the one or more inactive communication periods comprises a system information message type and the communication occasion comprises an occasion for transmitting one or more system information messages.

18. The network entity of claim 11, wherein the first message type that is permitted in the one or more inactive communication periods comprises a paging message type and the communication occasion comprises a paging channel occasion for transmitting one or more paging messages.

19. The network entity of claim 11, wherein the second message type comprises a periodic channel state information-reference signal type, a semi-persistent scheduling channel state information-reference signal type, a tracking reference signal type, a positioning reference signal type, a physical downlink control channel message scrambled with a UE-specific radio network temporary identifier type, a physical downlink control channel in a type 3 common search space message type, a semi-persistent scheduling physical downlink shared channel message type, a scheduling request message type, a periodic channel state information report type, a semi-persistent scheduling channel state information report type, a periodic sounding reference signal type, a semi-persistent scheduling sounding reference signal type, a configured grant physical uplink shared channel message type, a configured grant message type, a buffer status report message type, a physical uplink control channel message type, or a combination thereof.

20. A method for wireless communications by a user equipment (UE), comprising:
receiving, from a network entity, a message indicating a discontinuous communication configuration for restricting communication by the network entity during one or more inactive communication periods;
determining that a communication occasion overlaps with at least one inactive communication period of the one or more inactive communication periods, the communication occasion being associated with a first message type that is permitted in the one or more inactive communication periods; and
communicating, with the network entity, a first message during the at least one inactive communication period, the first message having a second message type that is restricted in the one or more inactive communication periods.

21. The method of claim 20, further comprising:
receiving, from the network entity, a control message indicating a configuration of one or more time offsets relative to the communication occasion, wherein the first message is communicated within a period including the communication occasion and the one or more time offsets and during the at least one inactive communication period.

22. The method of claim 20, further comprising:
receiving, from the network entity, a control message indicating a configuration of a threshold for determining whether one or more active communication periods of the discontinuous communication configuration are extended into at least a portion of the one or more inactive communication periods; and
determining that a duration between a first active communication period of the one or more active communication periods and the communication occasion satisfies the threshold, wherein the first message is communicated within a period including the communication occasion and an extension of the first active communication period into the duration in response to the determination.

23. The method of claim 20, further comprising:
activating one or more communication circuitries during at least a portion of the communication occasion that is during the at least one inactive communication period; and
deactivating the one or more communication circuitries during at least a portion of the at least one inactive communication period that is not during the communication occasion.

24. The method of claim 20, wherein:
the communication occasion that overlaps with the at least one inactive communication period is a first periodic communication occasion of a plurality of periodic communication occasions, and
the plurality of periodic communication occasions comprises a second periodic communication occasion that overlaps with at least one active communication period before the at least one inactive communication period.

25. The method of claim 20, further comprising:
communicating a second message of the first message type with the network entity during the communication occasion, wherein the second message comprises a random access message, a system information message, or a combination thereof.

26. A method for wireless communications by a network entity, comprising:
transmitting, to a user equipment (UE), a message indicating a discontinuous communication configuration for restricting communication by the network entity during one or more inactive communication periods;
determining that a communication occasion overlaps with at least one inactive communication period of the one or more inactive communication periods, the communication occasion being associated with a first message type that is permitted in the one or more inactive communication periods; and
communicating, with the UE, a first message during at least one inactive communication period, the first message having a second message type that is restricted in the one or more inactive communication periods.

27. The method of claim 26, further comprising:
transmitting, to the UE, a control message indicating a configuration of one or more time offsets relative to the communication occasion, wherein the first message is communicated within a period including the communication occasion and the one or more time offsets and during the at least one inactive communication period.

28. The method of claim 26, further comprising:
transmitting, to the UE, a control message indicating a configuration of a threshold for determining whether one or more active communication periods of the discontinuous communication configuration are extended into at least a portion of the one or more inactive communication periods; and
determining that a duration between a first active communication period of the one or more active communication periods and the communication occasion satisfies the threshold, wherein the first message is communicated within a period including the communication occasion and an extension of the first active communication period into the duration in response to the determination.

29. The method of claim 26, wherein:
the communication occasion that overlaps with the at least one inactive communication period is a first periodic communication occasion of a plurality of periodic communication occasions, and
the plurality of periodic communication occasions comprises a second periodic communication occasion that overlaps with at least one active communication period before the at least one inactive communication period.

30. The method of claim 26, further comprising:
communicating a second message of the first message type with the UE during the communication occasion, wherein the second message comprises a random access message, a system information message, or a combination thereof.
